(19) United States
(12) Patent Application Publication
(10) Pub. No.: US 2024/0184125 A1
(43) Pub. Date: Jun. 6, 2024

(54) IMAGE GENERATION DEVICE, IMAGE IRRADIATION DEVICE EQUIPPED WITH SAID IMAGE GENERATION DEVICE, AND IMAGE IRRADIATION DEVICE

(71) Applicant: KOITO MANUFACTURING CO., LTD., Tokyo (JP)

(72) Inventors: Takatomo Fujiyoshi, Shizuoka (JP); Masahiro Hori, Shizuoka (JP); Kohei Mochizuki, Shizuoka (JP); Takashi Ito, Shizuoka (JP)

(73) Assignee: KOITO MANUFACTURING CO., LTD., Tokyo (JP)

(21) Appl. No.: 18/285,327

(22) PCT Filed: Mar. 11, 2022
(86) PCT No.: PCT/JP2022/011074

§ 371 Date: Oct. 2, 2023

(30) Foreign Application Priority Data
Mar. 31, 2021 (JP) 2021-060971
Mar. 31, 2021 (JP) 2021-060972
Mar. 31, 2021 (JP) 2021-060973
Mar. 31, 2021 (JP) 2021-060974

(51) Int. Cl. G02B 27/01; G02B 26/08

(52) U.S. Cl. CPC G02B 27/0179; G02B 26/0816; G02B 27/0149

(57) ABSTRACT

An image generation device and an image irradiation device equipped with the image generation device are provided, which are capable of improving the position accuracy of an image generation unit and a first mirror, and achieving miniaturization of the first mirror. The image generation device for generating a predetermined image includes: an image generation unit configured to emit light for generating the predetermined image; a first mirror configured to reflect the light; and a bracket for attaching the image generation unit. The first mirror is held by the bracket.

### TECHNICAL FIELD

The present invention relates to an image generation device, an image irradiation device equipped with the image generation device, and an image irradiation device.

### BACKGROUND ART

In the future, it is expected that vehicles traveling in an autonomous driving mode and vehicles traveling in a manual driving mode coexist on a public road.

In a future autonomous driving society, it is expected that visual communication between a vehicle and a human being becomes increasingly important. For example, it is expected that visual communication between a vehicle and an occupant of the vehicle becomes increasingly important. In this respect, the visual communication between the vehicle and the occupant can be achieved by using a head-up display (HUD). The head-up display can achieve so-called augmented reality (AR) by projecting an image or a video on a windshield or a combiner, and allowing the occupant to visually recognize the image while superimposing the image on a real space through the windshield or the combiner.

Patent Literature 1 discloses a head-up display device including a display light emitting device that emits display light, a plane mirror that reflects the display light from the display light emitting device, and a concave mirror that reflects the display light reflected by the plane mirror and guides the display light to a windshield or a combiner. The head-up display device includes a housing that houses the display light emitting device, the plane mirror, a concave mirror, and the like.

Patent Literature 2 discloses a head-up display that reflects light for forming an image, which is emitted from an image generation unit, by a concave mirror and projects the light onto a windshield of a vehicle. A part of the light projected onto the windshield is reflected by the windshield and travels toward the eyes of a driver. The driver recognizes an actual object seen through the windshield as a background, and recognizes reflected light entering the eyes as a virtual image seen as an image of an object on the opposite side (an outer side of the vehicle) across the windshield.

The concave mirror is configured to be rotatable. The concave mirror is rotated to correspond to a viewpoint position of the driver so that the virtual image is displayed at a position corresponding to the viewpoint position of the driver. Accordingly, a position of the light projected onto the windshield is changed.

Patent Literature 3 discloses a head-up display that reflects light for forming an image, which is emitted from an image generation device, by a concave mirror and projects the light onto a windshield of a vehicle. The image generation device includes a light source, a lens that transmits light emitted from the light source, and a display device that forms light for generating an image by using the light transmitted through the lens.

Further, Patent Literature 4 discloses a head-up display that reflects light for forming an image, which is emitted from an image generation unit, by a concave mirror and projects the light onto a windshield of a vehicle.

### CITATION LIST

### Patent Literature

Patent Literature 1: JP2020-117106A
Patent Literature 2: JP2018-205509A
Patent Literature 3: JP2020-170067A
Patent Literature 4: WO2020/110580

### SUMMARY OF INVENTION

### Technical Problem

According to the head-up display in the related art as disclosed in Patent Literature 1, since a projector device and the plane mirror are individually fixed to the housing, the position accuracy of the projector device (an image generation device) and the plane mirror may decrease.

Therefore, an object of the invention is to provide an image generation device and an image irradiation device equipped with the image generation device, which are capable of improving the position accuracy of an image generation unit and a first mirror, and achieving miniaturization of the first mirror.

When the concave mirror is rotated to correspond to the viewpoint position of the driver, a length of an optical path between a reflection position of the light on the concave mirror and an incident position of the light on the windshield changes, and thus the quality of the virtual image changes.

Therefore, an object of the invention is to provide an image irradiation device that is capable of changing a display position of an image to correspond to a viewpoint position of an occupant and reducing a change in the quality of the image.

In addition, in the head-up display in Patent Literature 3, the display device may be arranged to be inclined with respect to a direction perpendicular to an optical axis of the light source in view of shapes and an arrangement relation of other components such as the concave mirror. In this case, a region of the display device near an emitting surface of the lens is brightly illuminated, and a region of the display device far from the emitting surface of the lens is darkly illuminated. As a result, light distribution unevenness may occur in the light emitted from the lens and radiated toward the display device.

Therefore, an object of the invention is to provide an image generation device and an image irradiation device that restrain light distribution unevenness of light radiated toward a display device inclined with respect to a direction perpendicular to an optical axis of a light source.

Further, in the head-up display in Patent Literature 4, for example, a heat sink is provided in order to dissipate heat generated accompanying light emission of a light source of the image generation unit, but there is room for improvement in a heat dissipation structure.

Therefore, an object of the invention is to provide an image irradiation device having excellent heat dissipation efficiency.

### Solution to Problem

In order to achieve one of the above objects, an image generation device according to one aspect of the invention is an image generation device for generating a predetermined image, the image generation device includes:
an image generation unit configured to emit light for generating the predetermined image;
a first mirror configured to reflect the light; and
a bracket for attaching the image generation unit, in which
the first mirror is held by the bracket.

Further, an image irradiation device according to one aspect of the invention includes:
the image generation device; and
a second mirror configured to reflect the light emitted from the image generation unit and reflected by the first mirror such that the light is radiated toward a transmission member.

Further, in order to achieve one of the above objects, an image irradiation device according to one aspect of the invention is an image irradiation device for a vehicle that displays a predetermined image, the image irradiation device includes:
an image generation unit configured to emit light for generating the predetermined image; and
a rotatably arranged reflecting portion having a reflecting surface for reflecting the light emitted from the image generation unit, in which
the reflecting surface has a curved surface having different curvature radii, and
the reflecting portion rotates such that the light incident on the reflecting portion is radiated toward the curved surface having different curvature radii.

When the reflecting portion is rotated, a reflecting direction of the light reflected by the reflecting surface changes. Accordingly, a length of an optical path between a reflection position of the light on the reflecting surface and an incident position of the light on a member onto which the reflected light is projected changes, and distortion occurs in the predetermined image. According to the above configurations, the light incident on the reflecting surface is reflected by the curved surface having different curvature radii in accordance with the rotation of the reflecting portion, so that the distortion of the predetermined image caused by the change in the length of the optical path is reduced. Therefore, a display position of the image can be changed to correspond to a viewpoint position of an occupant, and a change in the quality of the image is reduced.

Further, in order to achieve one of the above objects, an image generation device according to one aspect of the invention includes:
a light source;
a lens configured to transmit light emitted from the light source; and
a display device configured to form light for generating an image by using the light transmitted through the lens, in which
the display device is inclined with respect to a direction perpendicular to an optical axis of the light source, and
the light source is deviated from a predetermined position and arranged at a position corresponding to the inclination.

Further, in order to achieve one of the above objects, an image irradiation device according to one aspect of the invention is an image irradiation device for a vehicle that displays a predetermined image, the image irradiation device includes:
the image generation device; and
at least one reflecting portion configured to reflect the light emitted from the image generation device.

According to the above configurations, a part of the light emitted from the light source and transmitted through the lens is emitted toward a region of the display device far from the emitting surface of the lens. Therefore, it is possible to restrain light distribution unevenness of the light radiated toward the display device inclined with respect to the direction perpendicular to the optical axis of the light source.

Further, in order to achieve one of the above objects, an image irradiation device according to one aspect of the invention is an image irradiation device for a vehicle that displays a predetermined image, the image irradiation device includes:
an image generation unit including a light source and configured to emit light for generating the predetermined image by using light from the light source; and
a concave mirror configured to reflect the light emitted from the image generation unit, in which
an optical axis of the light source is inclined downward toward the concave mirror in a state where the image irradiation device is attached to a vehicle body of the vehicle.

According to the above configuration, the heat generated by the light source is transferred to the air and rises together with the air. Since the optical axis of the light source is inclined downward toward the concave mirror, the heat transferred to the air rises together with the air without being blocked by the components of the image generation unit. Accordingly, it is possible to provide an image irradiation device having excellent heat dissipation efficiency.

### Advantageous Effects of Invention

According to the invention, it is possible to provide an image generation device and a head-up display equipped with the image generation device, which are capable of improving the position accuracy of an image generation unit and a first mirror, and achieving miniaturization of the first mirror.

Further, according to the invention, it is possible to provide an image irradiation device that is capable of changing a display position of an image to correspond to a viewpoint position of an occupant and reducing a change in the quality of the image.

Further, according to the invention, it is possible to restrain light distribution unevenness of the light radiated toward the display device inclined with respect to the direction perpendicular to the optical axis of the light source.

In addition, according to the invention, it is possible to provide an image irradiation device having excellent heat dissipation efficiency.

### BRIEF DESCRIPTION OF DRAWINGS

FIG. 1 is a block diagram of a vehicle system including an image generation device and a head-up display (HUD) according to a first embodiment.

FIG. 2 is a schematic diagram illustrating a configuration of the HUD in FIG. 1.

FIG. 3 is a perspective view illustrating the image generation device and a concave mirror of the HUD in FIG. 1.

FIG. 4 is a perspective view illustrating a configuration of the image generation device in FIG. 1.

FIG. 5 is a sectional view illustrating an attached state of a plane mirror in FIG. 4.

FIG. 6 is a schematic diagram illustrating a configuration of a head-up display (HUD) according to a second embodiment.

FIG. 7 is a diagram illustrating optical paths of light for forming a virtual image object to be displayed at different positions corresponding to viewpoint positions of an occupant.

FIG. 8 is a diagram illustrating a region irradiated with light incident on the concave mirror on a reflecting surface of a concave mirror in FIG. 6.

FIG. 9 is a diagram illustrating a virtual image object visually recognized by the occupant when a viewpoint of the occupant is located at a reference position.

FIG. 10 is a diagram illustrating a virtual image object visually recognized by the occupant when the viewpoint of the occupant is located at a position higher than the reference position.

FIG. 11 is a diagram illustrating a virtual image object visually recognized by the occupant when the viewpoint of the occupant is located at a position lower than the reference position.

FIG. 12 is a diagram illustrating optical paths of the light for forming the virtual image object to be displayed at different positions corresponding to the viewpoint positions of the occupant.

FIG. 13 is a diagram illustrating the optical paths of the light for forming the virtual image object to be displayed at the different positions corresponding to the viewpoint positions of the occupant.

FIG. 14 is a diagram illustrating the region irradiated with the light incident on the concave mirror on the reflecting surface of the concave mirror in FIG. 6.

FIG. 15 is a diagram illustrating the virtual image object visually recognized by the occupant when the viewpoint of the occupant is at the reference position.

FIG. 16 is a diagram illustrating the virtual image object visually recognized by the occupant when the viewpoint of the occupant is located at the position higher than the reference position.

FIG. 17 is a diagram illustrating the virtual image object visually recognized by the occupant when the viewpoint of the occupant is located at the position lower than the reference position.

FIG. 18 is a schematic diagram illustrating a configuration of a head-up display (HUD) according to a third embodiment.

FIG. 19 is a schematic sectional view illustrating a configuration of an image generation device in FIG. 18.

FIG. 20 is a schematic sectional view illustrating a configuration of an image generation device according to a reference embodiment.

FIG. 21 is a schematic sectional view illustrating an optical path of light emitted from a light source in the image generation device in FIG. 19.

FIG. 22 is a schematic diagram illustrating a configuration of a head-up display (HUD) according to a fourth embodiment.

FIG. 23 is a schematic diagram for illustrating a configuration of an image generation unit of the HUD in FIG. 22.

FIG. 24 is a schematic diagram illustrating another example of the configuration of the image generation unit.

FIG. 25 is a schematic diagram illustrating another example of the configuration of the image generation unit.

FIG. 26 is a perspective view for illustrating a configuration of a heat sink in FIG. 25.

FIG. 27 is a schematic diagram illustrating another example of the configuration of the HUD.

### DESCRIPTION OF EMBODIMENTS

### First Embodiment

A first embodiment of the invention (hereinafter referred to as the present embodiment) will be described with reference to the drawings.

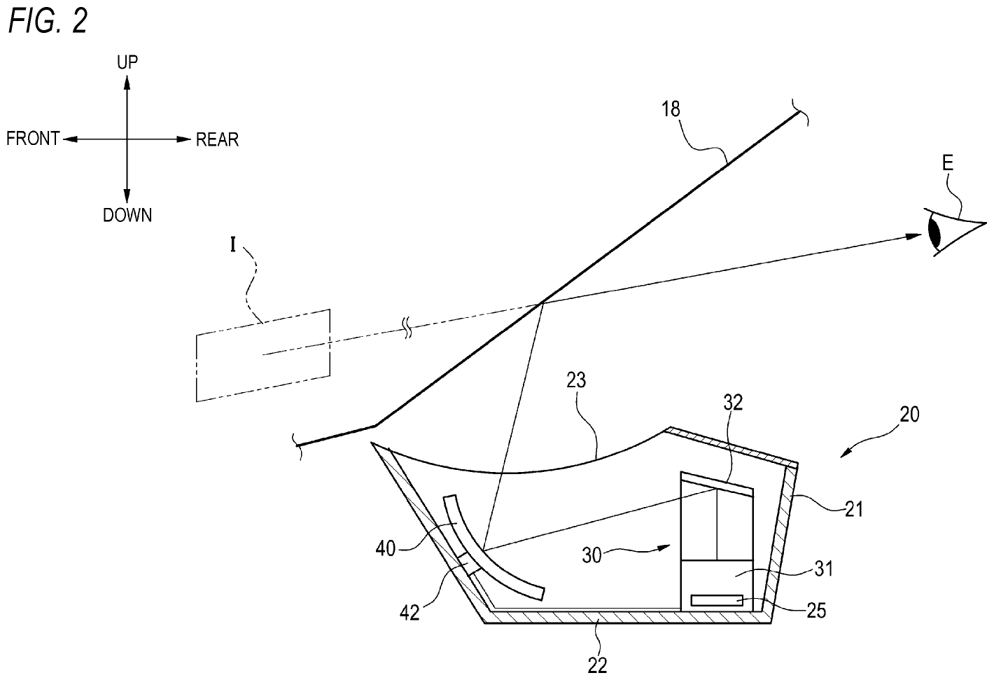

In the present embodiment, for convenience of description, a “left-right direction”, an “up-down direction”, and a “front-rear direction” may be appropriately referred to. Each of these directions is a relative direction set for a head-up display (HUD) 20 in FIG. 2. Here, the “left-right direction” is a direction that includes a “left direction” and a “right direction”. The “up-down direction” is a direction that includes an “up direction” and a “down direction”. The “front-rear direction” is a direction that includes a “front direction” and a “rear direction”. Although not illustrated in FIG. 2, the left-right direction is a direction orthogonal to the up-down direction and the front-rear direction.

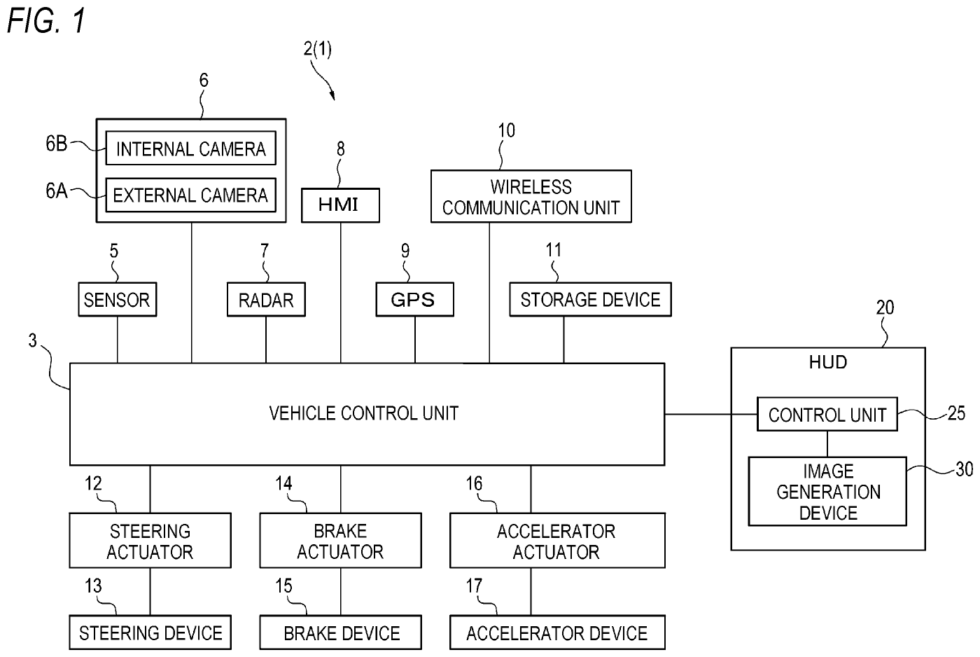

A vehicle system 2 including the HUD 20 according to the present embodiment will be described with reference to FIG. 1. A vehicle 1 on which the vehicle system 2 is mounted may be, for example, a vehicle (an automobile) capable of traveling in an autonomous driving mode.

As illustrated in FIG. 1, the vehicle system 2 includes a vehicle control unit 3, a sensor 5, a camera 6, a radar 7, a human machine interface (HMI) 8, a global positioning system (GPS) 9, a wireless communication unit 10, and a storage device 11. Further, the vehicle system 2 includes a steering actuator 12, a steering device 13, a brake actuator 14, a brake device 15, an accelerator actuator 16, and an accelerator device 17. The vehicle system 2 further includes the HUD 20.

The vehicle control unit 3 controls traveling of the vehicle 1. The vehicle control unit 3 includes, for example, at least one electronic control unit (ECU).

The sensor 5 includes at least one of an acceleration sensor, a speed sensor, and a gyro sensor. The sensor 5 detects a traveling state of the vehicle 1 and outputs traveling state information to the vehicle control unit 3. The sensor 5 may further include a seating sensor that detects whether a driver is sitting on a driver's seat, a face direction sensor that detects a direction of the face of the driver, an external weather sensor that detects an external weather condition, a human sensor that detects whether there is a person in the vehicle, and the like.

The camera 6 includes one or more external cameras 6A and an internal camera 6B. The external camera 6A acquires image data indicating the surrounding environment of the vehicle 1 and then transmits the image data to the vehicle control unit 3. The internal camera 6B is arranged inside the vehicle 1 and acquires image data indicating an occupant. The internal camera 6B functions as, for example, an eye tracking camera that tracks a viewpoint E (to be described later in FIG. 2) of the occupant. The internal camera 6B is provided, for example, near a room mirror or inside an instrument panel.

The radar 7 includes at least one of a millimeter wave radar, a microwave radar, and a laser radar (for example, a LiDAR unit). For example, the LiDAR unit acquires 3D mapping data (point cloud data) indicating the surrounding environment of the vehicle 1 and then transmits the 3D mapping data to the vehicle control unit 3.

The HMI 8 includes an input unit that receives an input operation from the driver and an output unit that outputs traveling information and the like to the driver. The input unit includes a steering wheel, an accelerator pedal, a brake pedal, a driving mode changeover switch for switching a driving mode of the vehicle 1, and the like. The output unit is a display (excluding the HUD) that displays various traveling information.

The GPS 9 acquires current position information of the vehicle 1 and outputs the acquired current position information to the vehicle control unit 3.

The wireless communication unit 10 receives information on one another vehicle around the vehicle 1 from the another vehicle and transmits information on the vehicle 1 to the another vehicle (vehicle-to-vehicle communication). In addition, the wireless communication unit 10 receives infrastructure information from infrastructure equipment such as a traffic light and a marker lamp, and transmits the traveling information on the vehicle 1 to the infrastructure equipment (road-to-vehicle communication). In addition, the wireless communication unit 10 receives information on a pedestrian from a mobile electronic device carried by the pedestrian, and transmits host vehicle traveling information on the vehicle 1 to the mobile electronic device (pedestrian-to-vehicle communication).

The storage device 11 is an external storage device such as a hard disk drive (HDD) or a solid state drive (SSD). The storage device 11 outputs map information and a vehicle control program to the vehicle control unit 3 in response to a request from the vehicle control unit 3.

When the vehicle 1 travels in the autonomous driving mode, the steering actuator 12 receives a steering control signal from the vehicle control unit 3 and controls the steering device 13. The brake actuator 14 receives a brake control signal from the vehicle control unit 3 and controls the brake device 15. The accelerator actuator 16 receives an accelerator control signal from the vehicle control unit 3 and controls the accelerator device 17.

The vehicle control unit 3 automatically controls the traveling of the vehicle 1 based on the traveling state information, surrounding environment information, the current position information, the map information, and the like. The driving mode includes the autonomous driving mode and a manual driving mode. In the autonomous driving mode, the traveling of the vehicle 1 is automatically controlled by the vehicle system 2. On the other hand, in the manual driving mode, the steering control signal, the accelerator control signal, and the brake control signal are generated by a manual operation of the driver, and thus the traveling of the vehicle 1 is controlled by the driver. The autonomous driving mode includes, for example, a fully autonomous driving mode, an advanced driving support mode, and a driving support mode.

The HUD 20 displays predetermined information (hereinafter referred to as HUD information) as an image to the occupant of the vehicle 1 such that the HUD information is superimposed on a real space outside the vehicle 1 (in particular, the surrounding environment in front of the vehicle 1). The HUD information displayed by the HUD 20 is, for example, the vehicle traveling information on the traveling of the vehicle 1 and/or the surrounding environment information on the surrounding environment of the vehicle 1 (in particular, information on an object present outside the vehicle 1). The HUD 20 is an AR display that functions as a visual interface between the vehicle 1 and the occupant.

The HUD 20 includes an image generation device (IGD, or, picture generation unit) 30 and a control unit 25.

The image generation device 30 emits light for generating a predetermined image to be displayed to the occupant of the vehicle 1. The image generation device 30 is capable of emitting, for example, light for generating a changeable image that changes according to a situation of the vehicle 1.

The control unit 25 controls operations of the parts of the HUD 20. The control unit 25 is connected to the vehicle control unit 3, generates a control signal for controlling an operation of the image generation device 30 based on, for example, the vehicle traveling information, the surrounding environment information, and the like transmitted from the vehicle control unit 3, and transmits the generated control signal to the image generation device 30. The control unit 25 is mounted with at least one processor such as a central processing unit (CPU) and at least one memory, and the processor executes a computer program read from the memory to control the operation of the image generation device 30 and the like. In the present embodiment, the vehicle control unit 3 and the control unit 25 are provided as separate components, and the vehicle control unit 3 and the control unit 25 may be integrally formed. For example, the vehicle control unit 3 and the control unit 25 may be implemented by a single electronic control unit.

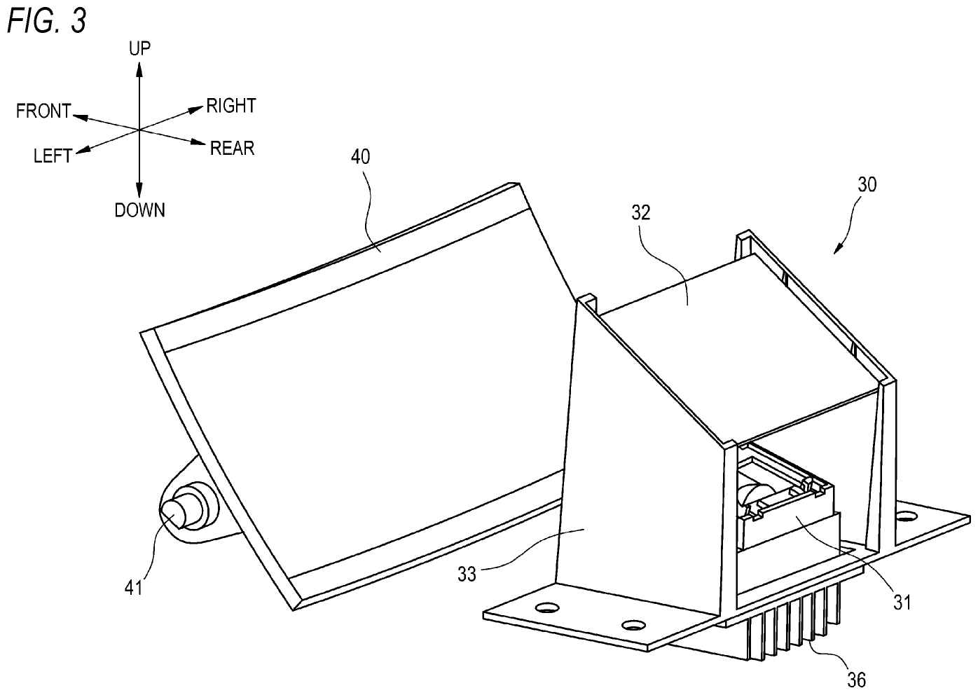

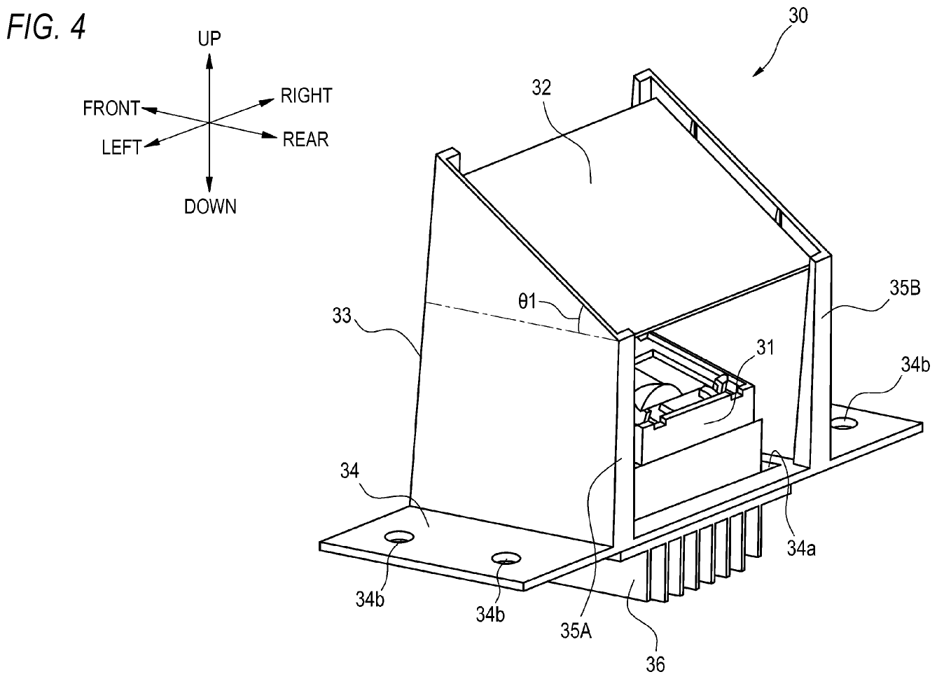

Next, a specific configuration of the HUD 20 according to the present embodiment will be described with reference to FIGS. 2 to 5. FIG. 2 is a schematic diagram of the HUD 20 mounted on the vehicle 1 as viewed from a side surface side of the vehicle 1. FIG. 3 is a diagram illustrating the image generation device 30 and a concave mirror 40. FIG. 4 is a perspective view illustrating a configuration of the image generation device 30.

As illustrated in FIG. 2, at least a part of the HUD 20 is located inside the vehicle 1. Specifically, the HUD 20 is provided at a predetermined position inside a cabin of the vehicle 1. For example, the HUD 20 may be arranged inside a dashboard of the vehicle 1.

The HUD 20 includes an HUD main body 21. The HUD main body 21 includes a housing portion 22 and an emitting window 23. The emitting window 23 is implemented by a transparent plate that transmits visible light. The HUD main body 21 includes the image generation device 30 and the concave mirror 40 (an example of a second mirror) inside the housing portion 22. In the present embodiment, the control unit 25 of the HUD 20 is accommodated in the image generation device 30.

As illustrated in FIGS. 2 and 3, the concave mirror 40 is provided in front of the image generation device 30 in the housing portion 22. The concave mirror 40 is arranged on an optical path of light emitted from the image generation device 30. The concave mirror 40 reflects the light emitted from the image generation device 30 toward a transmission member 18 (for example, a front window of the vehicle 1). The concave mirror 40 has a reflecting surface curved in a recessed shape in order to form a predetermined image, and reflects an image formed by the light emitted from the image generation device 30 at a predetermined magnification. A reflecting film is formed on the reflecting surface (a surface facing the image generation device 30) of the concave mirror 40 by, for example, depositing a metal such as aluminum.

The concave mirror 40 includes support shafts 41 on both left and right sides. The concave mirror 40 is supported by the housing portion 22 via the support shafts 41. In addition, the concave mirror 40 is rotatable about the support shafts 41 and is capable of changing an orientation with respect to the image generation device 30 by rotating. The concave mirror 40 includes, for example, a drive mechanism 42. The drive mechanism 42 can change a position and the orientation of the concave mirror 40 based on the control signal transmitted from the control unit 25.

The image generation device 30 is provided to face the concave mirror 40 in the housing portion 22. The light emitted from the image generation device 30 is reflected by the concave mirror 40 and is emitted from the emitting window 23 of the HUD main body 21. The light emitted from the emitting window 23 of the HUD main body 21 is radiated to the transmission member 18. A part of the light radiated from the emitting window 23 to the transmission member 18 is reflected toward the viewpoint E of the occupant. As a result, the occupant recognizes the light emitted from the image generation device 30 as a virtual image (the predetermined image) formed in front of the transmission member 18 at a predetermined distance. In this way, since the image displayed by the HUD 20 is superimposed on the real space in front of the vehicle 1 through the transmission member 18, the occupant can visually recognize that a virtual image object I formed by the predetermined image floats on a road located outside the vehicle.

Here, the viewpoint E of the occupant may be either a viewpoint of the left eye or a viewpoint of the right eye of the occupant. Alternatively, the viewpoint E may be defined as a midpoint of a line segment connecting the viewpoint of the left eye and the viewpoint of the right eye. A position of the viewpoint E of the occupant is specified based on, for example, the image data acquired by the internal camera 6B. The position of the viewpoint E of the occupant may be updated at a predetermined period, or may be determined only once when the vehicle 1 is started.

When a 2D image (a plane image) is formed as the virtual image object I, the predetermined image is projected to be a virtual image at any determined single distance. When a 3D image (a stereoscopic image) is formed as the virtual image object I, a plurality of the predetermined images that are the same or different from one another are projected to be virtual images at different distances. The distance of the virtual image object I (a distance from the viewpoint E of the occupant to the virtual image) can be appropriately adjusted by adjusting a distance from the image generation device 30 to the viewpoint E of the occupant (for example, adjusting a distance between the image generation device 30 and the concave mirror 40).

As illustrated in FIGS. 3 and 4, the image generation device 30 according to the present embodiment includes an image generation unit 31, a plane mirror 32 (an example of a first mirror), a bracket 33, and a heat sink 36.

The image generation unit 31 emits the light for generating a predetermined image. The image generation unit 31 is mounted on the bracket 33.

The plane mirror 32 is a member for reflecting the light emitted from the image generation unit 31 toward the concave mirror 40. The plane mirror 32 is provided between the image generation unit 31 and the concave mirror 40 on the optical path of the light emitted from the image generation unit 31. The plane mirror 32 is held by the bracket 33 on which the image generation unit 31 is mounted. The plane mirror 32 is arranged to form a certain angle with respect to a light emitting surface of the image generation unit 31 so as to reflect the light emitted from the image generation unit 31 toward the concave mirror 40. A reflecting film is formed on a reflecting surface (a lower surface facing the image generation unit 31) of the plane mirror 32 by, for example, depositing a metal such as aluminum. Instead of forming the reflecting film on the plane mirror 32 by aluminum deposition or the like, the plane mirror 32 itself may be made of a white-based resin material capable of reflecting light.

The bracket 33 is a member for attaching the image generation unit 31 to the housing portion 22. The bracket 33 is made of, for example, a resin material. The bracket 33 includes a base portion 34 and a pair of protrusions 35A and 35B protruding from the base portion 34.

The base portion 34 is implemented by a flat plate member of a rectangular shape. An opening 34a is provided in a central portion of the base portion 34, and the image generation unit 31 is attached in a state of being inserted into the opening 34a. Further, screw holes 34b for fixing the bracket 33 to the housing portion 22 are provided at left and right end portions of the base portion 34. The bracket 33 is fixed to the housing portion 22 such that an upper surface of the base portion 34 is parallel to a fixing surface of the housing portion 22 (for example, a bottom surface of the housing portion 22).

Each of the pair of protrusions 35A and 35B is implemented by a flat plate member of a trapezoidal shape. The pair of protrusions 35A and 35B are arranged to sandwich the image generation unit 31 fixed to the central portion of the base portion 34 in the left-right direction. Each of the protrusions 35A and 35B protrudes from the base portion 34 toward an emitting direction of the light emitted from the image generation unit 31, that is, toward an up direction of the HUD 20. A distal end portion of each of the protrusions 35A and 35B is formed to be inclined such that a rear side is lower than a front side. Further, the plane mirror 32 is attached to the distal end portions of the protrusions 35A and 35B along the inclination of the distal end portions. The plane mirror 32 is attached to cover an upper side between the protrusion 35A and the protrusion 35B. The front side and the rear side between the protrusion 35A and the protrusion 35B are in an open state. Side surfaces of the protrusions 35A and 35B on an image generation unit 31 side are preferably, for example, coated in black so as not to reflect the light emitted from the image generation unit 31.

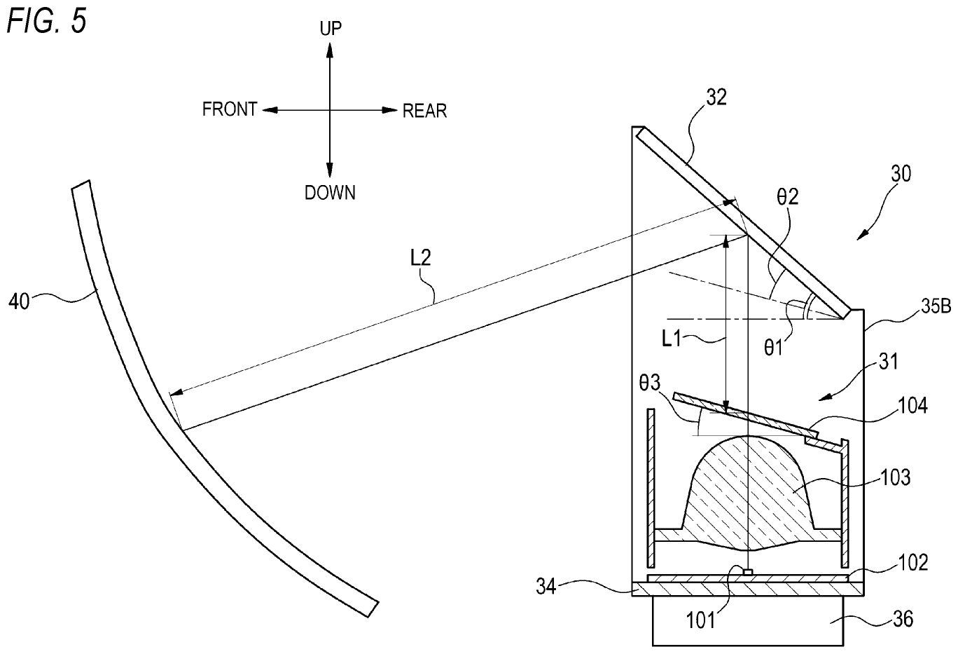

FIG. 5 is a sectional view of the image generation device 30 that illustrates a state where the plane mirror 32 is attached to the bracket 33. As illustrated in FIG. 5, the image generation unit 31 includes a light source 101 mounted on a substrate 102, a lens 103 arranged above the light source 101, and a display device 104 arranged above the lens 103. The heat sink 36 is attached below the substrate 102.

The lens 103 transmits or reflects the light emitted from the light source 101 and emits the light toward the display device 104. The display device 104 is, for example, a liquid crystal display, or a digital mirror device (DMD). An upper surface of the display device 104 constitutes the light emitting surface of the image generation unit 31 that emits light from the light source 101 transmitted through the lens 103 toward the plane mirror 32.

As illustrated in FIG. 4, the distal end portion of each of the protrusions 35A and 35B is inclined to have a certain angle θ1 with respect to a mounting surface of the base portion 34. The plane mirror 32 is attached along the inclination of the distal end portions of the protrusions 35A and 35B. That is, the plane mirror 32 is attached to the distal end portions of the protrusions 35A and 35B to have the angle θ1 with respect to the mounting surface of the base portion 34 on which the image generation unit 31 is mounted.

Further, the display device 104, which serves as the light emitting surface of the image generation unit 31, is attached to have an angle θ3 with respect to the mounting surface of the base portion 34 on which the image generation unit 31 is mounted. Accordingly, the reflected light of the light emitted from the light source 101 is prevented from being directly incident on the light source 101. The angle θ3 may be an angle at which the reflected light to be directly incident on the light source 101 can be restrained.

The angle θ1 formed by the plane mirror 32 and the mounting surface of the base portion 34 is larger than the angle θ3 formed by the display device 104, which serves as the light emitting surface of the image generation unit 31, and the mounting surface of the base portion 34. That is, the plane mirror 32 is attached to form a predetermined angle θ2 with respect to the display device 104. Here, θ2+θ3=θ1. As described above, since the plane mirror 32 is attached to the protrusions 35A and 35B of the bracket 33 to have the certain angle θ1, the light emitted from the light source 101 is reflected by the plane mirror 32, is further reflected by the concave mirror 40, and is radiated to the transmission member 18.

In addition, as illustrated in FIG. 5, a distance from the display device 104 to the plane mirror 32 is shorter than a distance from the plane mirror 32 to the concave mirror 40. That is, when the distance from the display device 104, which serves as the light emitting surface of the image generation unit 31, to the reflecting surface of the plane mirror 32 is set to L1 and the distance from the reflecting surface of the plane mirror 32 to the reflecting surface of the concave mirror 40 is set to L2, attachment positions of the respective members are set to satisfy L1<L2.

As described above, the image generation device 30 according to the present embodiment includes the image generation unit 31 that emits the light for generating the predetermined image, the plane mirror 32 (the example of the first mirror) that reflects the light emitted from the image generation unit 31, and the bracket 33 for attaching the image generation unit 31, and the plane mirror 32 is held by the bracket 33. According to this configuration, since the plane mirror 32 is held by the bracket 33, the image generation unit 31 and the plane mirror 32 are integrated. Therefore, a variation in the attachment position of the plane mirror 32 with respect to the image generation unit 31 can be restrained, and the position accuracy of the plane mirror 32 with respect to the image generation unit 31 can be improved. In addition, although the plane mirror 32 is a relatively expensive member subjected to an aluminum deposition process or the like, according to the present embodiment, since the position accuracy of the plane mirror 32 with respect to the image generation unit 31 is improved, the plane mirror 32 can be miniaturized, and a component cost can be reduced.

According to the image generation device 30, the bracket 33 includes the base portion 34 on which the image generation unit 31 is mounted, and the pair of protrusions 35A and 35B that are arranged to sandwich the image generation unit 31 and protrude from the base portion 34 in the emitting direction of the light from the image generation unit 31. Further, the plane mirror 32 is mounted on the pair of protrusions 35A and 35B. By using the bracket 33 having such a simple configuration, the position accuracy of the plane mirror 32 with respect to the image generation unit 31 can be improved, and the miniaturization of the plane mirror 32 can be achieved.

In addition, according to the image generation device 30, the distal end portion of each of the protrusions 35A and 35B forms the certain angle θ1 with respect to the mounting surface of the base portion 34 of the bracket 33 on which the image generation unit 31 is mounted, and the plane mirror 32 is attached to the distal end portions. Therefore, the plane mirror 32 can be integrated with the image generation unit 31 so that the angle formed by the display device 104, which serves as the light emitting surface of the image generation unit 31, and the reflecting surface of the plane mirror 32 becomes the desired angle θ2.

In addition, the head-up display 20 (an example of an image irradiation device) according to the present embodiment includes the image generation device 30, and the concave mirror 40 (the example of the second mirror) that reflects the light emitted from the image generation unit 31 and reflected by the plane mirror 32 such that the light is radiated toward the transmission member 18. According to this configuration, the light emitted from the image generation unit 31 is reflected by a plurality of mirror members such as the plane mirror 32 and the concave mirror 40, and thus it is possible to increase a length of an optical path from the image generation unit 31 in the housing portion 22 to the transmission member 18 while maintaining the position accuracy of the plane mirror 32. Accordingly, it is possible to achieve the miniaturization of the entire head-up display while ensuring the length of the optical path necessary for generating the virtual image (the predetermined image).

Further, according to the head-up display 20, the distance L1 between the display device 104, which serves as the light emitting surface of the image generation unit 31, and the reflecting surface of the plane mirror 32 is shorter than the distance L2 between the reflecting surface of the plane mirror 32 and the reflecting surface of the concave mirror 40. As described above, by shortening the distance L1 between the image generation unit 31 and the plane mirror 32, the spread of the emitted light at the time of reaching the plane mirror 32 can be restrained, and a deviation of an arrival position of the emitted light at the time of reaching the plane mirror 32 can be restrained. Therefore, the plane mirror 32 can be further miniaturized.

According to the above embodiment, the case where the bracket 33 of the image generation device 30 is made of a resin material has been described, but the invention is not limited thereto. For example, the bracket 33 may be made of a metal material (for example, an aluminum member) having excellent heat dissipation. According to this configuration, it is possible to cause the bracket 33 itself to function as a heat sink. In this case, for example, the heat sink 36 as in the embodiment described above may not be provided. Further, in addition to the heat sink 36 or instead of the heat sink 36, for example, a heat dissipation fin may be provided on an outer side surface of each of the protrusions 35A and 35B.

Further, according to the above embodiment, the configuration where the concave mirror 40 is supported by the housing portion 22 of the HUD main body 21 has been described, but the invention is not limited thereto. For example, the concave mirror 40 may be supported by the bracket 33 of the image generation device 30. In a case of a configuration where the concave mirror 40 is supported by the bracket 33 of the image generation device 30, the light emitted from the image generation unit 31 may be reflected by only the concave mirror 40 and radiated to the transmission member 18 without providing the plane mirror 32.

In addition, according to the above embodiment, the front window (a windshield) of the vehicle 1 is given as an example of the transmission member 18, but the invention is not limited thereto. For example, the transmission member 18 may be a combiner (not shown) provided inside the front window. The combiner is implemented by, for example, a transparent plastic disk. A part of the light radiated from the image generation device 30 of the HUD main body 21 toward the combiner is reflected toward the viewpoint E of the occupant similarly to the case where the light is radiated to the front window.

Further, classifications and display forms of the driving mode of the vehicle may be appropriately changed according to laws or rules relating to the autonomous driving in individual countries. Similarly, the definitions of the “fully autonomous driving mode”, the “advanced driving support mode”, and the “driving support mode” described in the present embodiment are merely examples, and the definitions thereof may be appropriately changed according to laws or rules relating to the autonomous driving in individual countries.

### Second Embodiment

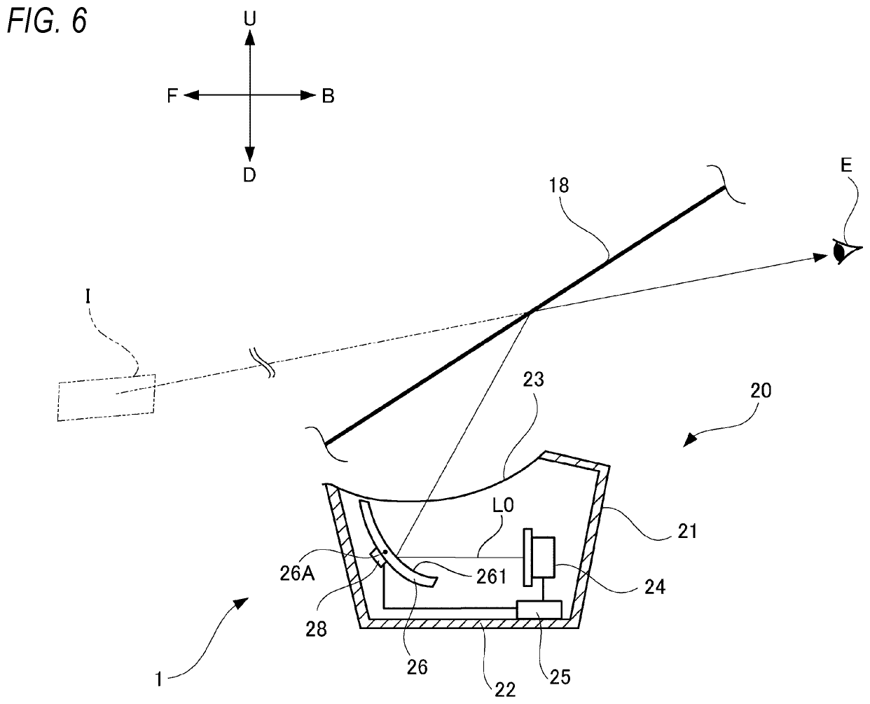

Hereinafter, a second embodiment of the invention will be described with reference to the drawings. For the sake of convenience of description, dimensions of the respective members shown in the drawings may be different from actual dimensions of the respective members. In the drawings, an arrow U indicates an up direction of an illustrated structure. An arrow D indicates a down direction of the illustrated structure. An arrow F indicates a front direction of the illustrated structure. An arrow B indicates a rear direction of the illustrated structure. An arrow L indicates a left direction of the illustrated structure. An arrow R indicates a right direction of the illustrated structure. Each of these directions is a relative direction set for the HUD 20 in FIG. 6.

FIG. 6 is a schematic diagram of the HUD 20 according to the second embodiment as viewed from the side surface side of the vehicle 1. The HUD 20 is provided in the vehicle 1. For example, the HUD 20 is arranged inside the dashboard of the vehicle 1. The HUD 20 is an example of the image irradiation device.

The HUD 20 functions as the visual interface between the vehicle 1 and the occupant of the vehicle 1. Specifically, the HUD 20 displays the predetermined information as the predetermined image such that the information is superimposed on the real space outside the vehicle 1 (in particular, the surrounding environment in front of the vehicle 1). The image may include a still image or a moving image (a video). The information displayed by the HUD 20 is, for example, the vehicle traveling information on the traveling of the vehicle 1 and/or the surrounding environment information on the surrounding environment of the vehicle 1 (in particular, the information on the object present outside the vehicle 1).

As illustrated in FIG. 6, the HUD 20 includes the HUD main body 21. The HUD main body 21 includes the housing portion (a housing) 22 and the emitting window 23. The emitting window 23 is implemented by a transparent plate that transmits visible light. The HUD main body 21 includes an image generation unit (IGU, or picture generation unit) 24, the control unit 25, a concave mirror 26, and a drive mechanism 28 inside the housing portion 22. The concave mirror 26 is an example of a reflecting portion.

The image generation unit 24 emits light for generating a predetermined image. The image generation unit 24 is fixed to the housing portion 22. The light emitted from the image generation unit 24 is, for example, visible light. Although not illustrated in detail, the image generation unit 24 includes a light source, an optical component, and a display device. The light source is, for example, an LED light source or a laser light source. The LED light source is, for example, a white LED light source. The laser light source is, for example, an RGB laser light source that emits a red laser beam, a green laser beam, and a blue laser beam. The optical component appropriately includes a prism, a lens, a diffusion plate, a magnifying glass, and the like. The optical component transmits light emitted from the light source and emits the light toward the display device. The display device is a liquid crystal display, a DMD, or the like. A plotting method of the image generation unit 24 may be a raster scan method, a digital light processing (DLP) method, or a liquid crystal on silicon (LCOS) method. When the DLP method or the LCOS method is adopted, the light source of the image generation unit 24 may be an LED light source. When a liquid crystal display method is adopted, the light source of the image generation unit 24 may be a white LED light source.

The control unit 25 controls operations of the parts of the HUD 20. The control unit 25 is connected to the vehicle control unit (not shown) of the vehicle 1, generates a control signal for controlling an operation of the image generation unit 24 based on, for example, the vehicle traveling information, the surrounding environment information, and the like transmitted from the vehicle control unit, and transmits the generated control signal to the image generation unit 24. The control unit 25 is mounted with the processor such as a CPU and the memory, and the processor executes a computer program read from the memory to control the operation of the image generation unit 24 and the like.

The concave mirror 26 is arranged on an optical path of the light emitted from the image generation unit 24. Specifically, the concave mirror 26 is arranged on a front side of the image generation unit 24 inside the housing portion 22. The concave mirror 26 reflects upward the light emitted from the image generation unit 24 toward the transmission member 18 (for example, the front window of the vehicle 1). The concave mirror 26 reflects, by a reflecting surface 261, an image formed by the light emitted from the image generation unit 24 at a predetermined magnification. The concave mirror 26 has the reflecting surface 261 curved in a recessed shape. The reflecting surface 261 has a curved surface having different curvature radii. For example, the reflecting surface 261 may be formed to have different curvature radii along the up-down direction. The curvature radius may change continuously or may change stepwise for each predetermined range.

The drive mechanism 28 can change a position of the concave mirror 26 (an orientation of the reflecting surface 261) based on the control signal transmitted from the control unit 25. The concave mirror 26 is displaced to a predetermined position by being rotated about a rotational shaft 26A by the drive mechanism 28.

The light emitted from the image generation unit 24 is reflected by the concave mirror 26 and is emitted from the emitting window 23 of the HUD main body 21. The light emitted from the emitting window 23 of the HUD main body 21 is radiated to the transmission member 18. A part of the light radiated from the emitting window 23 to the transmission member 18 is reflected toward the viewpoint E of the occupant. As a result, the occupant recognizes the light emitted from the HUD main body 21 as a virtual image (the predetermined image) formed in front of the transmission member 18 at a predetermined distance. In this way, since the image displayed by the HUD 20 is superimposed on the real space in front of the vehicle 1 through the transmission member 18, the occupant can visually recognize that a virtual image object I formed by the predetermined image floats on a road located outside the vehicle.

When a 2D image (a plane image) is formed as the virtual image object I, the predetermined image is projected to be a virtual image at any determined single distance. When a 3D image (a stereoscopic image) is formed as the virtual image object I, a plurality of the predetermined images that are the same or different from one another are projected to be virtual images at different distances. The distance of the virtual image object I (the distance from the viewpoint E of the occupant to the virtual image) can be appropriately adjusted by adjusting a distance from the image generation unit 24 to the viewpoint E of the occupant. For example, the distance of the virtual image object I can be appropriately adjusted by adjusting a length of an optical path between the image generation unit 24 and the concave mirror 26.

A display position of the virtual image object I is changed according to the position of the viewpoint E of the occupant. For example, the position of the viewpoint E of the occupant may be specified by the control unit 25 based on the image data acquired by the camera arranged inside the vehicle 1. The viewpoint E of the occupant may be either the viewpoint of the left eye or the viewpoint of the right eye of the occupant. Alternatively, the viewpoint E may be defined as a midpoint of a line segment connecting the viewpoint of the left eye and the viewpoint of the right eye.

The control unit 25 generates a control signal based on the specified position of the viewpoint E of the occupant. The drive mechanism 28 rotates the concave mirror 26 based on the control signal. When the position of the concave mirror 26 (the orientation of the reflecting surface 261) is displaced, an incident position of the light projected onto the transmission member 18 is changed. As a result, the virtual image object I is displayed at a position corresponding to the position of the viewpoint E of the occupant. The position of the viewpoint E of the occupant may be specified based on an input operation from the occupant.

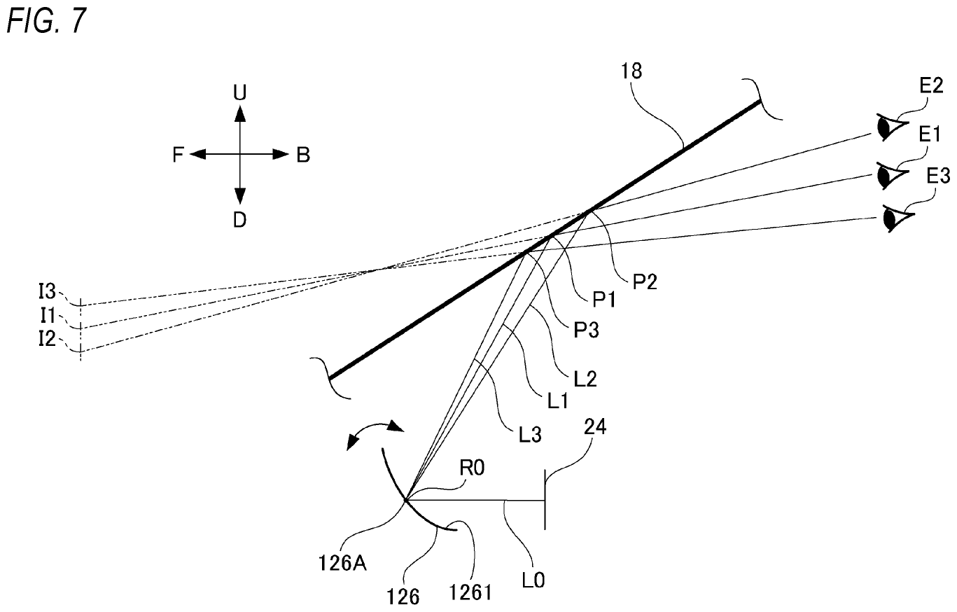

FIG. 7 illustrates optical paths of light reflected from a concave mirror 126 in a case where display positions of virtual image objects I1 to I3 are changed to correspond to viewpoints E1 to E3 of the occupant at different heights, which is a reference embodiment. FIG. 7 illustrates the optical paths of the light formed when a rotational shaft 126A intersects an optical axis of the light incident on the concave mirror 126. The “optical axis of the light” means an axis of light at the center of a light flux, and each of the optical paths in FIG. 7 indicates a path of the optical axis of the light.

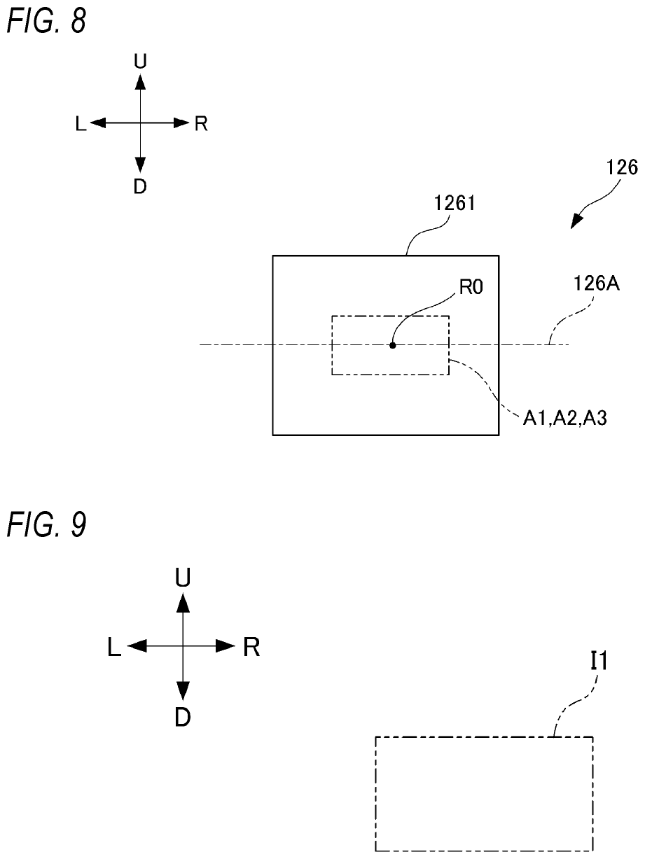

For example, when the concave mirror 126 is located at a predetermined position (a position serving as a reference of rotation), the light emitted from the image generation unit 24 travels along an optical path L0 and is incident on a predetermined point R0 on the concave mirror 126. As illustrated in FIG. 8, on a reflecting surface 1261, a predetermined region A1 centered on the point R0 is irradiated with the light emitted from the image generation unit 24. The light reflected by the concave mirror 126 travels along an optical path L1 and is incident on a point P1 of the transmission member 18. A part of the light incident on the point P1 of the transmission member 18 is reflected toward the viewpoint E1 of the occupant. As a result, the virtual image object I1 is visually recognized by the occupant having the viewpoint E1. As illustrated in FIG. 9, the virtual image object I1 has a rectangular shape corresponding to the predetermined region A1.

On the other hand, as illustrated in FIG. 7, when the viewpoint E2 of the occupant is located at a position higher than the viewpoint E1, the concave mirror 126 is rotated on an image generation unit 24 side. Since the rotational shaft 126A of the concave mirror 126 intersects the optical axis of the light incident on the concave mirror 126, even when the concave mirror 126 is rotated, the light emitted from the image generation unit 24 is incident on the predetermined point R0 on the concave mirror 126. That is, as illustrated in FIG. 8, on the reflecting surface 1261, similarly to the region A1, a predetermined region A2 centered on the point R0 is irradiated with the light emitted from the image generation unit 24. The light reflected by the concave mirror 126 travels along an optical path L2 and is incident on a point P2 of the transmission member 18. A part of the light incident on the point P2 of the transmission member 18 is reflected toward the viewpoint E2 of the occupant. As a result, the virtual image object 12 is visually recognized by the occupant having the viewpoint E2.

When the viewpoint E3 of the occupant is located at a position lower than the viewpoint E1, the concave mirror 126 is rotated on a side opposite to the image generation unit 24. Since the rotational shaft 126A of the concave mirror 126 intersects the optical axis of the light incident on the concave mirror 126, the light emitted from the image generation unit 24 is incident on the predetermined point R0 on the concave mirror 126. That is, as illustrated in FIG. 8, on the reflecting surface 1261, similarly to the region A1, a predetermined region A3 centered on the point R0 is irradiated with the light emitted from the image generation unit 24. The light reflected by the concave mirror 126 travels along an optical path L3 and is incident on a point P3 of the transmission member 18. A part of the light incident on the point P3 of the transmission member 18 is reflected toward the viewpoint E3 of the occupant. As a result, the virtual image object I3 is visually recognized by the occupant having the viewpoint E3.

However, when the viewpoints E2 and E3 of the occupant are located at positions different from the viewpoint E1, as will be described later, lengths of optical paths between point (reflection position) R0 on the concave mirror 126 where the light is incident on and the points (incident positions) P2 and P3 on the transmission member 18 where the light is incident on are changed. Accordingly, distortion occurs in the displayed virtual image objects 12 and I3.

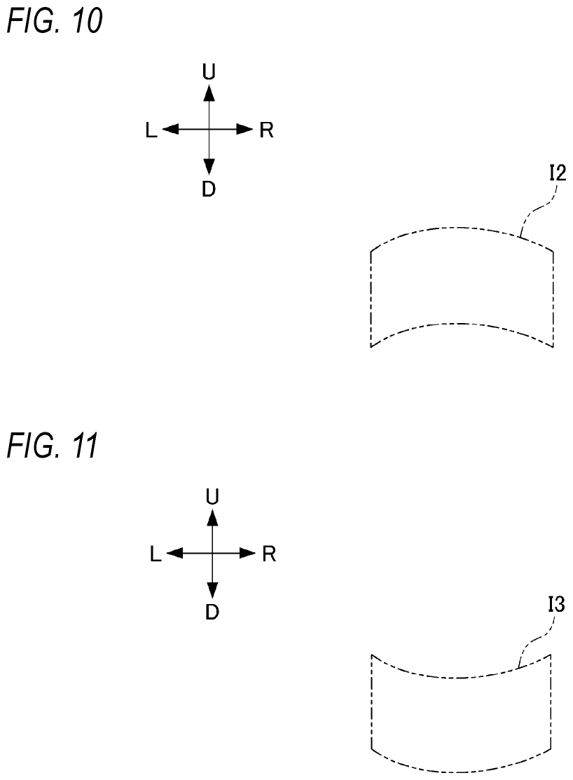

For example, in the case of the viewpoint E2 of the occupant, the length of the optical path between the point R0 on the concave mirror 126 and the point P2 on the transmission member 18 is longer than a length of an optical path between a point R0 on the concave mirror 126 where the light is incident on and the point P1 on the transmission member 18 where the light is incident on. Accordingly, as illustrated in FIG. 10, the distortion occurs in the virtual image object 12, and the virtual image object 12 has a shape in which an upper side and a lower side are curved upward in a protruding shape.

Alternatively, in the case of the viewpoint E3 of the occupant, the length of the optical path between the point R0 on the concave mirror 126 where the light is incident on and the point P3 on the transmission member 18 where the light is incident on is shorter than the length of the optical path between the point R0 on the concave mirror 126 where the light is incident on and the point P1 on the transmission member 18 where the light is incident on. Accordingly, as illustrated in FIG. 11, the distortion occurs in the virtual image object I3, and the virtual image object I3 has a shape in which an upper side and a lower side are curved downward in a protruding shape.

In contrast, the concave mirror 26 according to the present embodiment rotates such that the light incident on the concave mirror 26 is radiated to the curved surface having different curvature radii. For example, the concave mirror 26 is arranged such that the rotational shaft 26A does not intersect the optical axis of the light emitted from the image generation unit 24 and incident on the concave mirror 26. In this example, as illustrated in FIG. 6, the reflecting surface 261 has different curvature radii along the up-down direction, and the rotational shaft 26A is deviated upward with respect to the optical axis of the light incident on the concave mirror 26.

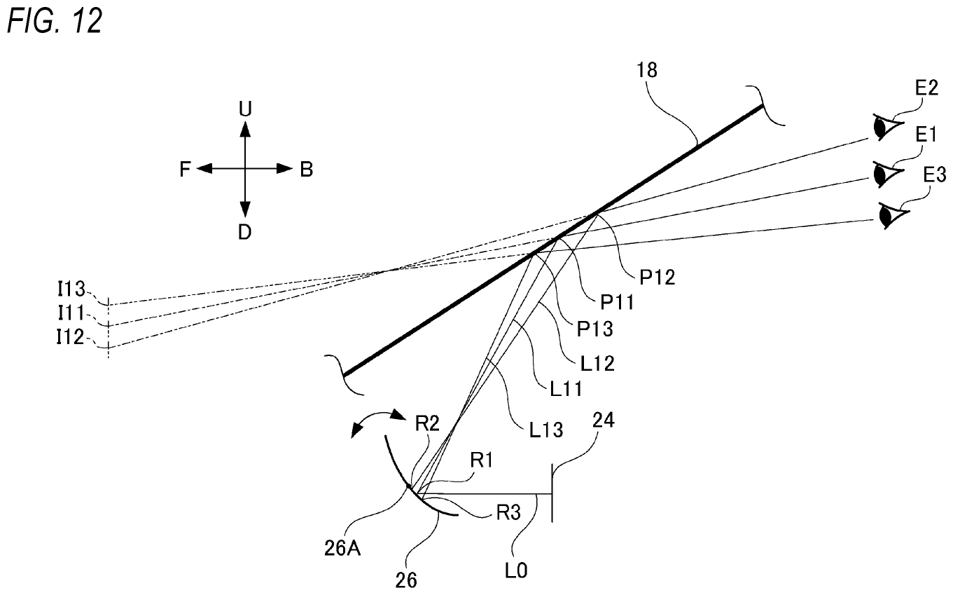

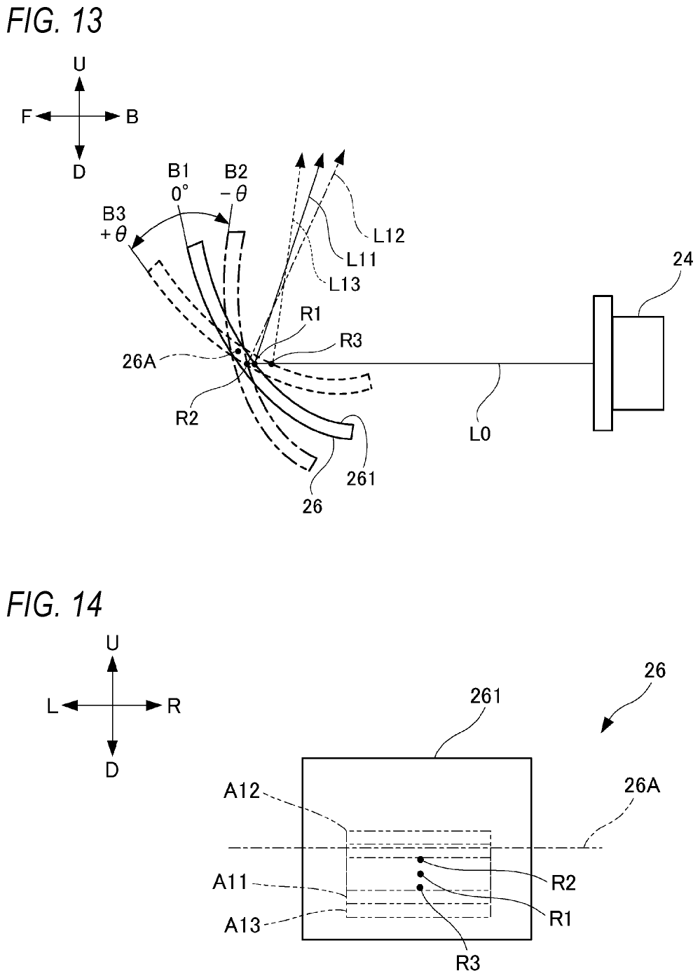

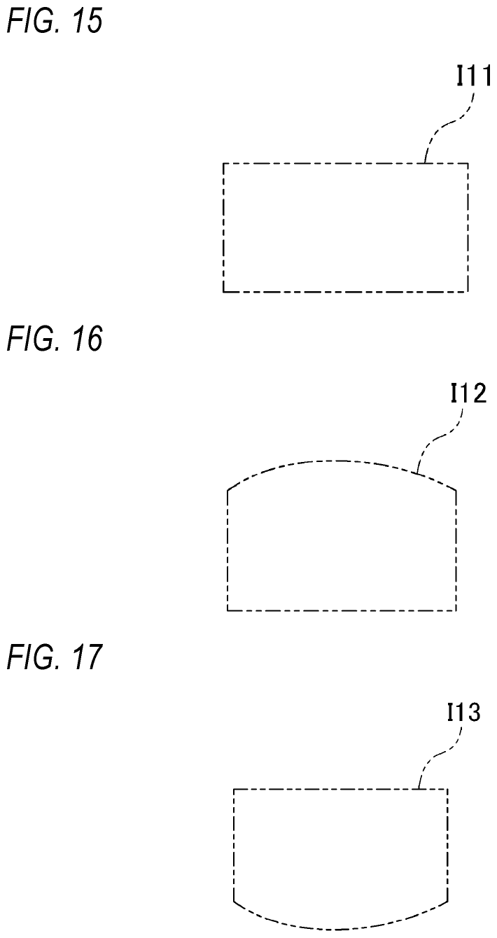

FIGS. 12 and 13 illustrate optical paths of the light reflected from the concave mirror 26 according to the present embodiment. As illustrated in FIGS. 12 and 13, when the concave mirror 26 is located at a predetermined position B1 (a position serving as a reference of rotation), the light emitted from the image generation unit 24 travels along the optical path L0 and is incident on the predetermined point R1 on the concave mirror 26. As illustrated in FIG. 14, on the reflecting surface 261, a predetermined region A11 centered on the point R1 located below the rotational shaft 26A is irradiated with the light emitted from the image generation unit 24. The light reflected by the concave mirror 26 travels along an optical path L11 and is incident on a point P11 of the transmission member 18. A part of the light incident on the point P11 of the transmission member 18 is reflected toward the viewpoint E1 of the occupant. As a result, a virtual image object I11 is visually recognized by the occupant having the viewpoint E1. As illustrated in FIG. 15, the virtual image object I11 has a rectangular shape corresponding to the predetermined region A11.

On the other hand, as illustrated in FIG. 12, when the viewpoint E2 of the occupant is located at the position higher than the viewpoint E1, the concave mirror 26 is rotated on the image generation unit 24 side. As illustrated in FIG. 13, the concave mirror 26 is displaced to a position B2 rotated by about-θ from the position B1. Since the rotational shaft 26A is deviated upward with respect to the optical axis of the light incident on the concave mirror 26, the light emitted from the image generation unit 24 is incident on the point R2 located above the point R1 on the concave mirror 26. As illustrated in FIG. 14, on the reflecting surface 261, a region A12 centered on the point R2 is irradiated with the light emitted from the image generation unit 24. The light reflected by the concave mirror 26 travels along an optical path L12 and is incident on a point P12 of the transmission member 18. A part of the light incident on the point P12 of the transmission member 18 is reflected toward the viewpoint E2 of the occupant. As a result, a virtual image object I12 is visually recognized by the occupant having the viewpoint E2.

When the viewpoint E3 of the occupant is located at the position lower than the viewpoint E1, the concave mirror 26 is rotated on the side opposite to the image generation unit 24. As illustrated in FIG. 13, the concave mirror 26 is displaced to a position B3 rotated by about +θ from the position B1. Since the rotational shaft 26A is deviated upward with respect to the optical axis of the light incident on the concave mirror 26, the light emitted from the image generation unit 24 is incident on the point R3 located below the point R1 on the concave mirror 26. As illustrated in FIG. 14, on the reflecting surface 261, a region A13 centered on the point R3 is irradiated with the light emitted from the image generation unit 24. The light reflected by the concave mirror 26 travels along an optical path L13 and is incident on a point P13 of the transmission member 18. A part of the light incident on the point P13 of the transmission member 18 is reflected toward the viewpoint E3 of the occupant. As a result, a virtual image object I13 is visually recognized by the occupant having the viewpoint E3.

When the viewpoints E2 and E3 of the occupant are located at the positions different from the viewpoint E1, lengths of optical paths between points R12 and R13 on the concave mirror 26 where the light is incident on and the points P12 and P13 on the transmission member 18 where the light is incident on are changed. However, the light incident on the reflecting surface 261 of the concave mirror 26 is reflected by the regions A12 and A13 each having a curved surface with a curvature radius different from a curvature radius of a curved surface of the region A11. Accordingly, the distortion of the virtual image objects I12 and I13 caused by the changes in the lengths of the optical paths is reduced. Therefore, the display position of the virtual image can be changed to correspond to the position of the viewpoint E of the occupant, and a change in the quality of the virtual image is reduced.

In the present embodiment, as illustrated in FIG. 14, the HUD 20 may have a configuration where the regions A11 and A12 irradiated with the light incident on the concave mirror 26 partially overlap each other. Similarly, the HUD 20 may have a configuration where the regions A11 and A13 irradiated with the light incident on the concave mirror 26 partially overlap each other. The regions A11 and A12 or the regions A11 and A13 are examples of a first irradiation region and a second irradiation region. According to such a configuration, the increase in the size of the concave mirror 26 is restrained while the distortion of the virtual image objects I12 and I13 is reduced.

Further, the HUD 20 may have a configuration where the regions A11, A12, and A13 do not overlap one another. In this case, the size of the concave mirror 26 is increased, but the distortion of the virtual image objects I12 and I13 can be further reduced as compared with a case where the regions A11, A12, and A13 partially overlap one another.

In the present embodiment, the reflecting surface 261 may be formed such that a curvature radius of a region located on an upper side is larger than a curvature radius of a region located on a lower side. The curvature radius may change to increase upward, or may change stepwise for each predetermined range.

According to such a configuration, for example, in a case where a length of an optical path between the point R2 on the reflecting surface 261 where the light is incident on and the point P12 on the transmission member 18 where the light is incident on is long, the distortion of the virtual image object I12 can be restrained by reflecting the light in the region on the upper side of the reflecting surface 261 where the curvature radius is large. For example, as illustrated in FIG. 16, the virtual image object I12 where the distortion on the lower side is reduced may be formed.

For example, in a case where a length of an optical path between the point R3 on the reflecting surface 261 where the light is incident on and the point P13 on the transmission member 18 where the light is incident on is short, the distortion of the virtual image object I13 can be restrained by reflecting the light in the region on the lower side of the reflecting surface 261 where the curvature radius is small. For example, as illustrated in FIG. 17, the virtual image object I13 where the distortion on the upper side is reduced may be formed.

In the above embodiment, the light emitted from the image generation unit 24 may be incident on the concave mirror 26 via the optical component such as a plane mirror.

In the above embodiment, the entire reflecting surface 261 is curved in a recessed shape. However, the reflecting surface 261 may adopt a configuration where at least a partial region thereof is curved in a recessed shape, and a curved surface having different curvature radii is formed in the region curved in a recessed shape.

In the above embodiment, the rotational shaft 26A is deviated upward with respect to the optical axis of the light incident on the concave mirror 26. However, the HUD 20 may have a configuration where the rotational shaft 26A is deviated downward with respect to the optical axis of the light incident on the concave mirror 26.

In the above embodiment, the concave mirror 26 is arranged such that the rotational shaft 26A does not intersect the optical axis of the light emitted from the image generation unit 24 and incident on the concave mirror 26. However, as long as the concave mirror 26 is configured to rotate such that the light incident on the concave mirror 26 is radiated to the curved surface having different curvature radii, the HUD 20 may have other configurations.

In the above embodiment, the light emitted from the image generation unit 24 is reflected by the concave mirror 26 and is radiated to the transmission member 18. However, for example, the light reflected by the concave mirror 26 may be radiated to the combiner (not shown) provided inside the transmission member 18. The combiner is implemented by, for example, a transparent plastic disk. A part of the light radiated from the image generation unit 24 of the HUD main body 21 toward the combiner is reflected toward the viewpoint E of the occupant similarly to the case where the light is radiated to the transmission member 18.

### Third Embodiment

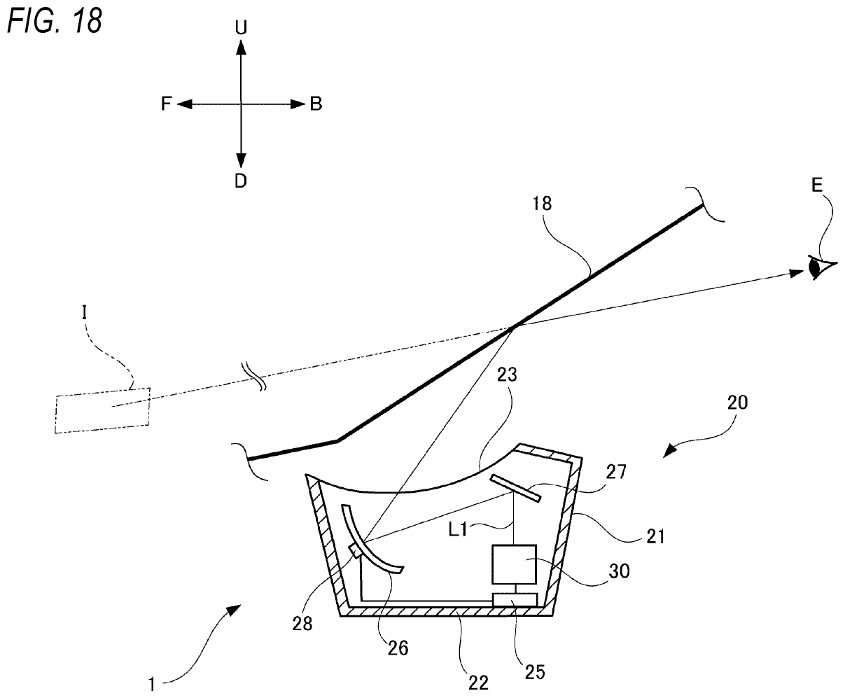

Hereinafter, a third embodiment of the invention will be described with reference to the drawings. FIG. 18 is a schematic diagram of the HUD 20 according to the third embodiment as viewed from the side surface side of the vehicle 1. As illustrated in FIG. 18, the HUD 20 includes the HUD main body 21. The HUD main body 21 includes the housing portion 22 and the emitting window 23. The emitting window 23 is implemented by a transparent plate that transmits visible light. The HUD main body 21 includes the image generation device (IGD, or picture generation unit) 30, the control unit 25, the concave mirror 26, and a plane mirror 27 inside the housing portion 22. The concave mirror 26 is an example of a reflecting portion.

The image generation device 30 emits the light for generating a predetermined image. The image generation device 30 is fixed to the housing portion 22. The light emitted from the image generation device 30 is, for example, visible light.

The control unit 25 controls operations of the parts of the HUD 20. The control unit 25 is connected to the vehicle control unit (not shown) of the vehicle 1, generates a control signal for controlling an operation of the image generation device 30 based on, for example, the vehicle traveling information, the surrounding environment information, and the like transmitted from the vehicle control unit, and transmits the generated control signal to the image generation device 30. The control unit 25 is mounted with the at least one processor such as a CPU and the at least one memory, and the processor executes a computer program read from the memory to control the operation of the image generation device 30 and the like.

The plane mirror 27 is arranged on the optical path of the light emitted from the image generation device 30. Specifically, the plane mirror 27 is arranged above the image generation device 30, and reflects the light emitted from the image generation device 30 toward the concave mirror 26. The plane mirror 27 has a planar reflecting surface, and reflects an image formed by the light emitted from the image generation device 30 at the same magnification.

The concave mirror 26 is arranged on an optical path of light emitted from the image generation device 30 and reflected by the plane mirror 27. Specifically, the concave mirror 26 is arranged on a front side of the image generation device 30 and the plane mirror 27 inside the housing portion 22. The concave mirror 26 reflects the light emitted from the image generation device 30 toward the transmission member 18 (for example, the front window of the vehicle 1). The concave mirror 26 has the reflecting surface curved in a recessed shape. The concave mirror 26 reflects an image formed by the light emitted from the image generation device 30 at a predetermined magnification. The concave mirror 26 may be rotatable by the drive mechanism 28.

In the HUD 20 configured as described above, as illustrated in FIG. 18, light L1 emitted from the image generation device 30 is reflected by the concave mirror 26 and the plane mirror 27 and is emitted from the emitting window 23 of the HUD main body 21. The light emitted from the emitting window 23 of the HUD main body 21 is radiated to the transmission member 18. A part of the light radiated from the emitting window 23 to the transmission member 18 is reflected toward the viewpoint E of the occupant. As a result, the occupant recognizes the light emitted from the HUD main body 21 as a virtual image (the predetermined image) formed in front of the transmission member 18 at a predetermined distance. In this way, since the image displayed by the HUD 20 is superimposed on the real space in front of the vehicle 1 through the transmission member 18, the occupant can visually recognize that a virtual image object I formed by the predetermined image floats on a road located outside the vehicle.

When a 2D image (a plane image) is formed as the virtual image object I, the predetermined image is projected to be a virtual image at any determined single distance. When a 3D image (a stereoscopic image) is formed as the virtual image object I, a plurality of the predetermined images that are the same or different from one another are projected to be virtual images at different distances. The distance of the virtual image object I (the distance from the viewpoint E of the occupant to the virtual image) can be appropriately adjusted by adjusting the distance from the image generation device 30 to the viewpoint E of the occupant (for example, adjusting a length of an optical path between the image generation device 30 and the concave mirror 26).

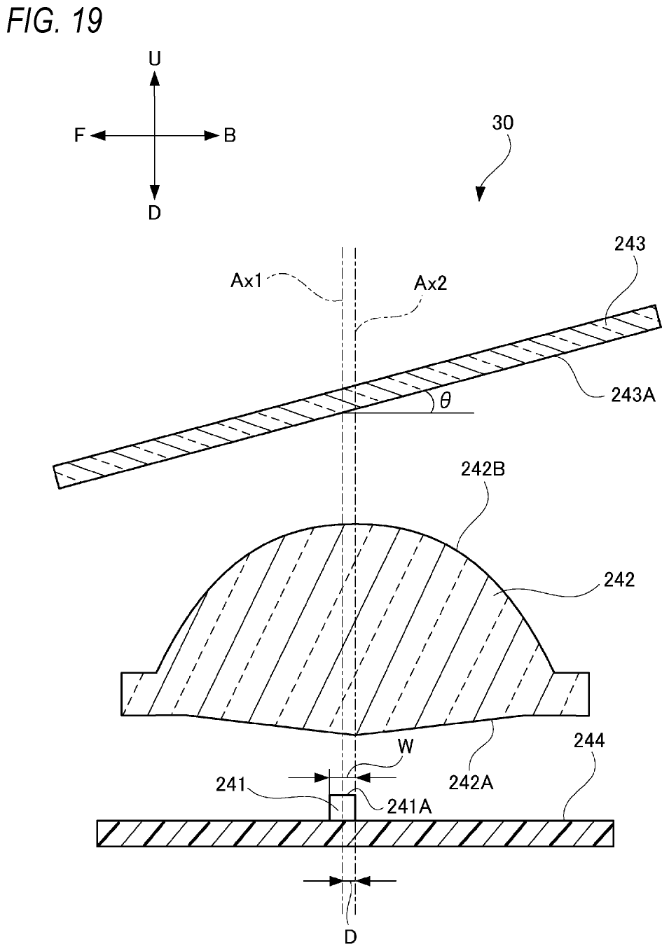

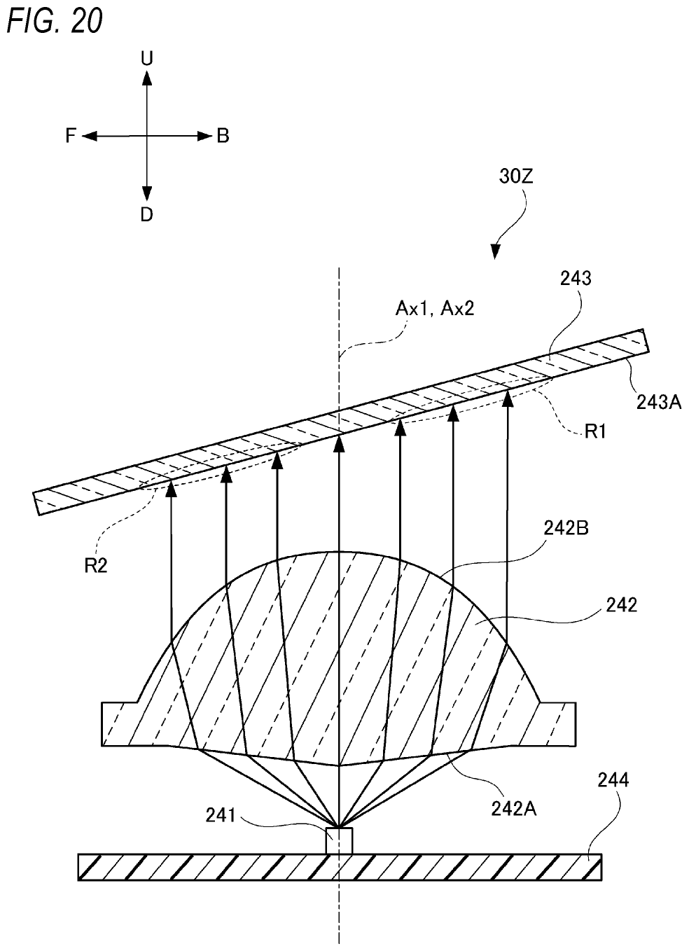

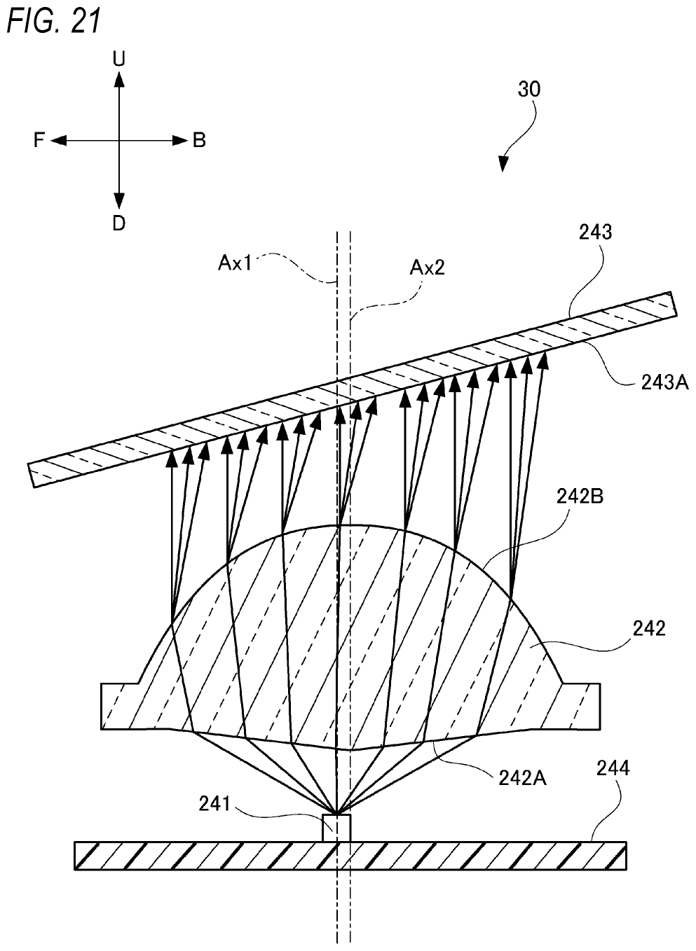

Next, the configuration of the image generation device 30 will be described with reference to FIG. 19. As illustrated in FIG. 19, the image generation device 30 includes a light source 241, a lens 242, and a display device 243. The lens 242 is arranged above the light source 241. The display device 243 is arranged above the lens 242. The image generation device 30 may further include a lens holder, a heat sink, and the like.

The light source 241 is, for example, an LED light source or a laser light source. The LED light source is, for example, a white LED light source. The laser light source is, for example, an RGB laser light source that emits a red laser beam, a green laser beam, and a blue laser beam. The light source 241 is mounted on a substrate 244. The substrate 244 is, for example, a printed circuit board made of an insulator where wiring of an electric circuit is printed on a surface of or inside the insulator.

The lens 242 transmits light emitted from the light source 241 and emits the light toward the display device 243. The lens 242 is, for example, an aspherical convex lens where both an incident surface 242A on which the light from the light source 241 is incident and an emitting surface 242B from which the incident light is emitted are formed in a projecting surface shape.

The display device 243 forms light for generating a predetermined image by using the light of the light source 241 transmitted through the lens 242. The display device 243 is, for example, a liquid crystal display, a DMD, or the like.

The display device 243 is arranged to be inclined with respect to a direction perpendicular to an optical axis Ax1 of the light source 241 (in this example, the front-rear direction). Specifically, an incident surface 243A of the display device 243 on which the light emitted from the lens 242 is incident is inclined by about an angle θ with respect to the direction perpendicular to the optical axis Ax1 of the light source 241. The phrase “the optical axis of the light source 241” used in the present description means a light line having the highest luminance among light emitted from the light source 241. For example, when the light source 241 is an LED light source, an optical axis of the LED light source means a straight line that passes through a center with the highest luminance in a light emitting surface 241A of the LED light source and is parallel to a normal line of the light emitting surface 241A.

The light source 241 is arranged at a position corresponding to the inclination of the display device 243. The position where the light source 241 is arranged is deviated from a predetermined position. The “predetermined position” is, for example, a position corresponding to a rear focal position of the lens 242. The deviation (a distance) of the position of the light source 241 with respect to the predetermined position can be appropriately set according to the inclination angle θ of the display device 243 with respect to the direction perpendicular to the optical axis Ax1 of the light source 241. For example, the light source 241 is arranged at a position that is farther away from the predetermined position as the inclination angle θ of the display device 243 increases.

The light source 241 is deviated, due to the inclination of the display device 243, from the predetermined position in a direction in which the incident surface 243A of the display device 243 is close to the emitting surface 242B of the lens 242 (the front direction in FIG. 19). That is, the light source 241 is arranged to be deviated from the predetermined position in a direction corresponding to an inclination direction of the display device 243. In this example, the optical axis Ax1 of the light source 241 is parallel to an optical axis Ax2 of the lens 242, and the incident surface 243A of the display device 243 is deviated toward a side close to the emitting surface 242B of the lens 242 with respect to the optical axis Ax2. For example, a distance D of the deviation of the optical axis Ax1 with respect to the optical axis Ax2 is 0.5 mm when the inclination angle θ is about 15 [deg] and the light source 241 is an LED light source having a square shape in a plan view where a width W in each of longitudinal and lateral directions is 1 mm.

For example, when the light source 241 is arranged at the rear focal position of the lens 242, as illustrated in FIG. 20, the light emitted from the light source 241 of an image generation device 30Z according to the reference embodiment is incident on the incident surface 242A of the lens 242. Since the lens 242 is in an aspherical convex lens shape, the light emitted from the light source 241 is incident on the lens 242, becomes light parallel to the optical axis Ax1 from the emitting surface 242B, and is incident on the display device 243.

However, since the display device 243 is inclined with respect to the direction perpendicular to the optical axis Ax1 of the light source 241, in the incident surface 243A of the display device 243, an amount of light incident on a region R1 away from the emitting surface 242B of the lens 242 is smaller than an amount of light incident on a region R2 close to the emitting surface 242B of the lens 242. As a result, light distribution unevenness may occur in the light emitted from the lens 242 and radiated to the display device 243.

Regarding the above, in the image generation device 30 according to the present embodiment, the light source 241 is deviated from the predetermined position and is arranged at the position corresponding to the inclination of the display device 243. Accordingly, as illustrated in FIG. 21, a part of the light emitted from the light source 241 and emitted from the emitting surface 242B of the lens 242 is emitted toward a direction opposite to the direction of the deviation from the predetermined position of the light source 241 (the rear direction in this example). Therefore, it is possible to restrain the light distribution unevenness of the light radiated to the display device 243 inclined with respect to the direction perpendicular to the optical axis Ax1 of the light source 241.

In the present embodiment, the optical axis Ax1 of the light source 241 is deviated with respect to the optical axis Ax2 of the lens 242 in a state where the optical axis Ax1 is parallel to the optical axis Ax2. According to such a configuration, by only deviating the position of the light source 241 on the substrate 244, it is possible to restrain the light distribution unevenness with a simple configuration without changing the shape or the orientation of the lens 242.

The image generation device 30 may include two or more light sources 241.

The lens 242 is the aspherical convex lens where both the incident surface 242A and the emitting surface 242B are formed in the projecting surface shape, but may be a lens having another shape.

The light emitted from the image generation device 30 is reflected by the concave mirror 26 and is radiated to the transmission member 18, but the invention is not limited thereto. For example, the light reflected by the concave mirror 26 may be radiated to the combiner (not shown) provided inside the transmission member 18. The combiner is implemented by, for example, a transparent plastic disk. A part of the light radiated from the image generation device 30 of the HUD main body 21 toward the combiner is reflected toward the viewpoint E of the occupant similarly to the case where the light is radiated to the transmission member 18.

### Fourth Embodiment

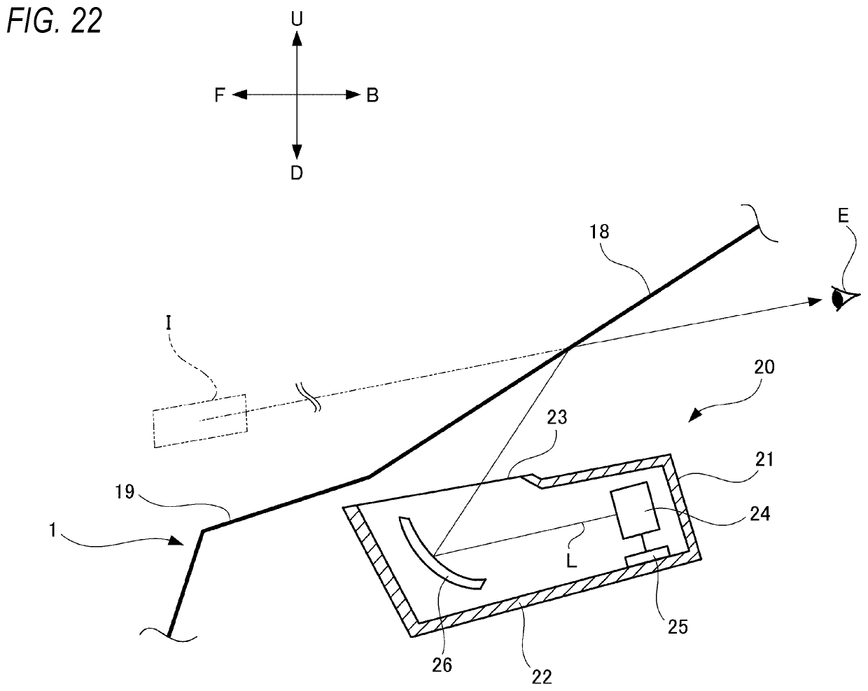

Hereinafter, a fourth embodiment of the invention will be described with reference to the drawings. FIG. 22 is a schematic diagram of the HUD 20 according to the fourth embodiment as viewed from the side surface side of the vehicle 1. As illustrated in FIG. 22, the HUD 20 includes the HUD main body 21. The HUD main body 21 includes the housing portion 22 and the emitting window 23. The emitting window 23 is implemented by a transparent plate that transmits visible light. The HUD main body 21 includes the image generation unit (IGU, or picture generation unit) 24, the control unit 25, and the concave mirror 26. The image generation unit 24, the control unit 25, and the concave mirror 26 are accommodated in the housing portion 22. The concave mirror 26 is an example of a reflecting portion.

The image generation unit 24 emits light L for generating a predetermined image. The image generation unit 24 is fixed to the housing portion 22. The light emitted from the image generation unit 24 is, for example, visible light.

The control unit 25 controls operations of the parts of the HUD 20. The control unit 25 is connected to the vehicle control unit (not shown) of the vehicle 1. The control unit 25 generates the control signal for controlling the operation of the image generation unit 24 based on, for example, the vehicle traveling information and/or the surrounding environment information transmitted from the vehicle control unit, and transmits the generated control signal to the image generation unit 24.

The control unit 25 is mounted with the at least one processor such as a CPU and the at least one memory. The operation of the image generation unit 24 and the like is controlled by the processor executing the computer program read from the memory. The control unit 25 may be integrally formed with the vehicle control unit. In this respect, the control unit 25 and the vehicle control unit may be implemented by a single electronic control unit.

The concave mirror 26 is arranged on an optical path of the light L emitted from the image generation unit 24. Specifically, the concave mirror 26 is arranged on a front side of the image generation unit 24 inside the housing portion 22. The concave mirror 26 reflects the light L emitted from the image generation unit 24 toward the transmission member 18 (for example, the front window of the vehicle 1). The concave mirror 26 has the reflecting surface curved in a recessed shape. The concave mirror 26 reflects the image formed by the light emitted from the image generation unit 24 at the predetermined magnification. The concave mirror 26 may be rotatable by the drive mechanism (not shown).

As illustrated in FIG. 22, in a state where the HUD 20 is attached to a vehicle body 19 of the vehicle 1, the light L emitted from the image generation unit 24 is emitted obliquely forward and downward toward the concave mirror 26. The light L emitted from the image generation unit 24 is reflected by the concave mirror 26 and is emitted from the emitting window 23 of the HUD main body 21. The light emitted from the emitting window 23 of the HUD main body 21 is radiated to the transmission member 18. A part of the light radiated from the emitting window 23 to the transmission member 18 is reflected toward the viewpoint E of the occupant. As a result, the occupant recognizes the light emitted from the HUD main body 21 as a virtual image (the predetermined image) formed in front of the transmission member 18 at a predetermined distance. In this way, since the image displayed by the HUD 20 is superimposed on the real space in front of the vehicle 1 through the transmission member 18, the occupant can visually recognize that a virtual image object I formed by the predetermined image floats on a road located outside the vehicle.

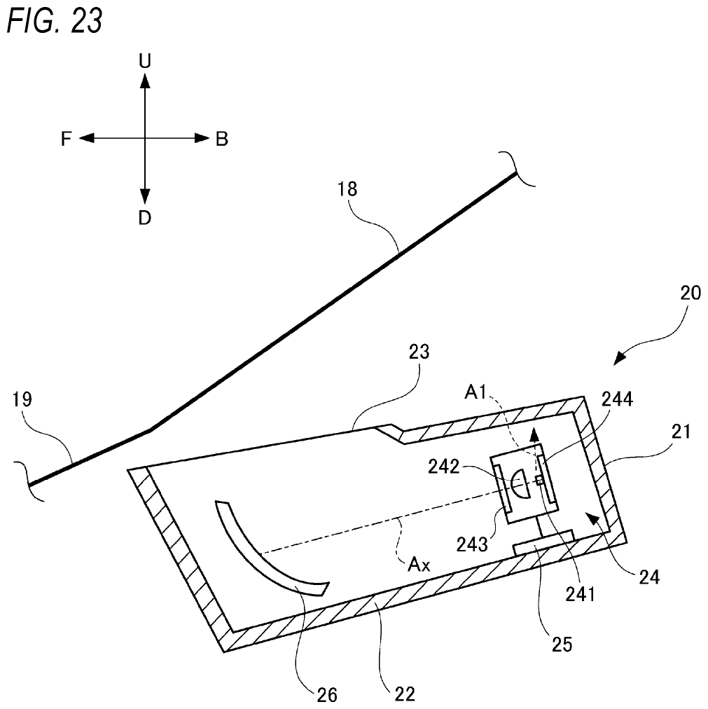

As illustrated in FIG. 23, the image generation unit 24 includes the light source 241, the lens 242 as an example of the optical component, the display device 243, and the substrate (a wiring board) 244. The light source 241 is, for example, an LED light source or a laser light source. The LED light source is, for example, a white LED light source. The laser light source is, for example, an RGB laser light source that emits a red laser beam, a green laser beam, and a blue laser beam. The light source 241 is mounted on a substrate 244.

The lens 242 appropriately includes a prism, a lens, a diffusion plate, a magnifying glass, and the like. In this example, the image generation unit 24 includes a lens as the lens 242. The lens 242 transmits the light emitted from the light source 241 and emits the light toward the display device 243. The display device 243 is a liquid crystal display, a digital mirror device (DMD), or the like. The display device 243 forms light for generating a predetermined image by using the light of the light source 241 transmitted through the lens 242.

As illustrated in FIG. 23, in the state where the HUD 20 is attached to the vehicle body 19, the optical axis Ax of the light source 241 is inclined downward toward the concave mirror 26. The phrase “the optical axis of the light source 241” used in the present description means a light line having the highest luminance among light emitted from the light source 241. For example, when the light source 241 is an LED light source, the optical axis of the LED light source means the straight line that passes through the center with highest luminance of the light emitting surface of the LED light source and is parallel to the normal line of the light emitting surface.

The light source 241 generates heat when emitting light. The heat generated by the light source 241 is transferred to air A1 and rises together with the air. Since an optical axis Ax of the light source 241 is inclined downward toward the concave mirror 26, the heat transferred to the air rises together with air A1 without being blocked by the lens 242 and the display device 243. Accordingly, it is possible to provide the HUD 20 having excellent heat dissipation efficiency. In addition, it is possible to restrain the lens 242 and the display device 243 from being affected by the heat generated by the light source 241.

The substrate 244 of the image generation unit 24 may include a base board made of a metal. For example, the base board may be made of aluminum. An insulating layer is formed on the base board, and a wiring layer is formed on the insulating layer. When the base board is made of a metal, the substrate 244 functions as a heat dissipation member that dissipates the heat generated by the light source 241. That is, the heat generated by the light source 241 is transferred to the substrate 244, and is more efficiently dissipated by the base board of the substrate 244.

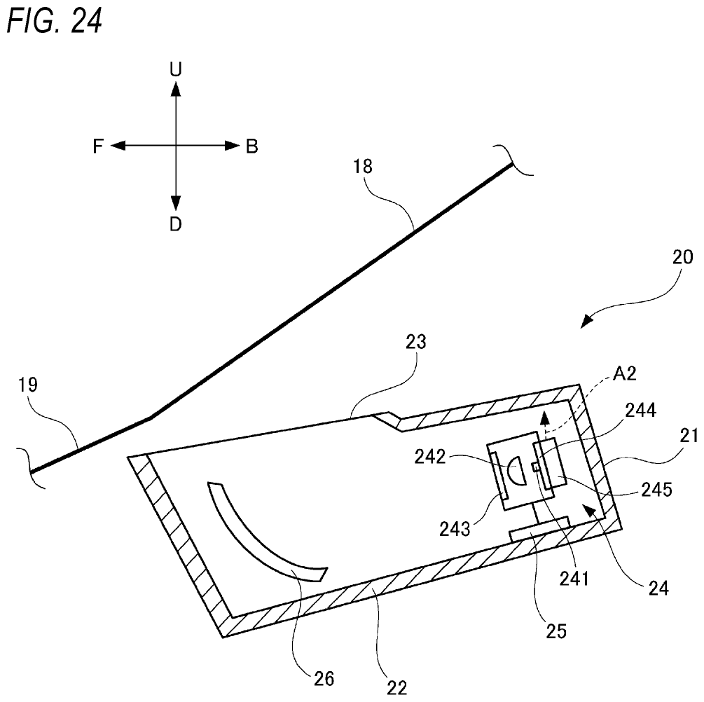

As illustrated in FIG. 24, the image generation unit 24 may include a heat sink 245 that dissipates the heat generated from the light source 241. The heat sink 245 may be arranged such that in the state where the HUD 20 is attached to the vehicle body 19, at least a part of the heat sink 245 is located above the light source 241. In this example, the heat sink 245 is provided to cover an entire surface of the substrate 244 opposite to the surface on which the light source 241 is mounted.

The heat generated by the light source 241 is transferred to the heat sink 245, and is more efficiently dissipated by the heat sink 245. Since a part of the heat sink 245 is located above the light source 241, the heat transferred from the heat sink 245 to the air is not blocked by the image generation unit 24 and rises together with air A2. Therefore, the heat dissipation efficiency is improved.

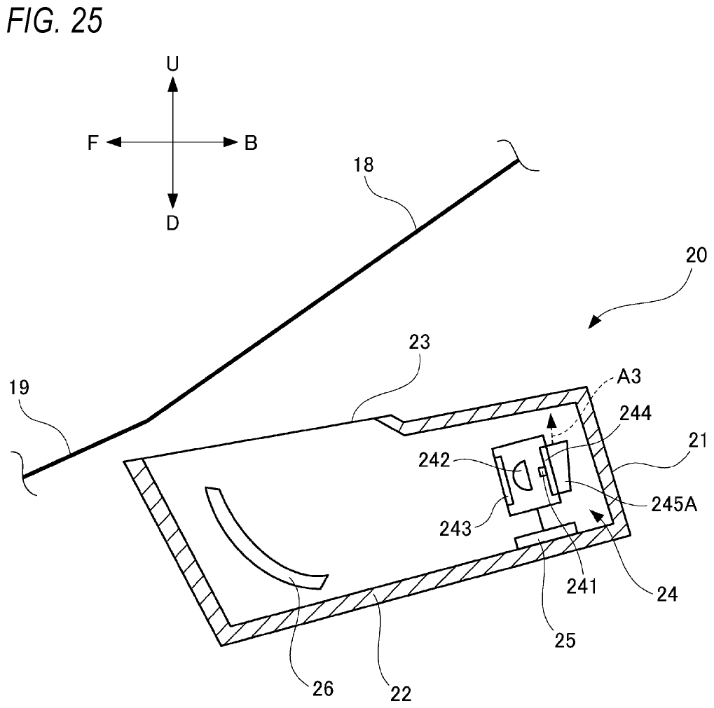

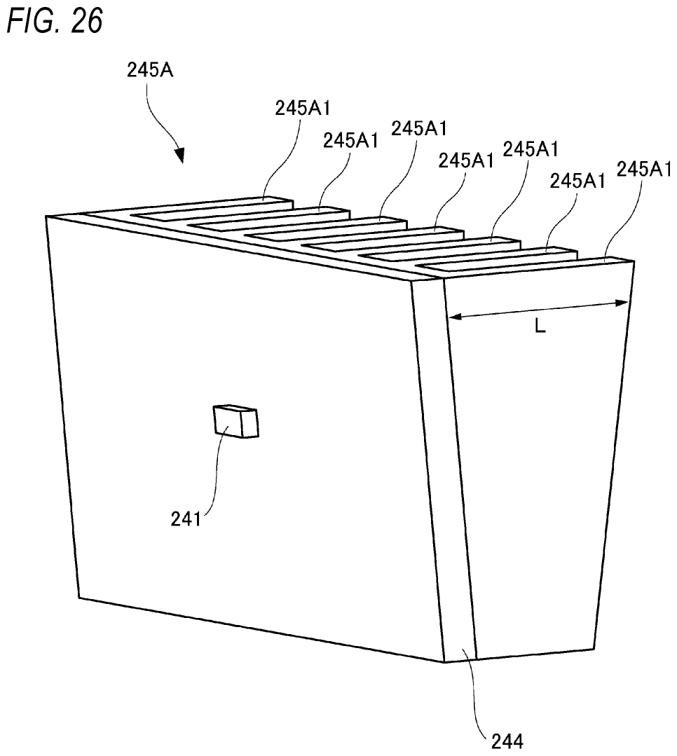

As illustrated in FIGS. 25 and 26, a heat sink 245A may include a plurality of fins 245A1. Each of the plurality of fins 245A1 protrudes in a direction opposite to the emitting direction of the light of the light source 241. Each of the plurality of fins 245A1 may be formed such that a length L (FIG. 26) in a protruding direction increases toward an upper side in the state where the HUD 20 is attached to the vehicle body 19.

The heat generated by the light source 241 is transferred from the heat sink 245A to the air and rises together with air A3. Since the length at an upper portion of each of the fins 245A1 in the protruding direction is long, the heat transferred to the heat sink 245A is easily and efficiently dissipated from an upper portion of the heat sink 245A.

The number of the light sources 241 and the number of the fins 245A1 mounted on the substrate 244 are not limited to those illustrated in FIG. 26.

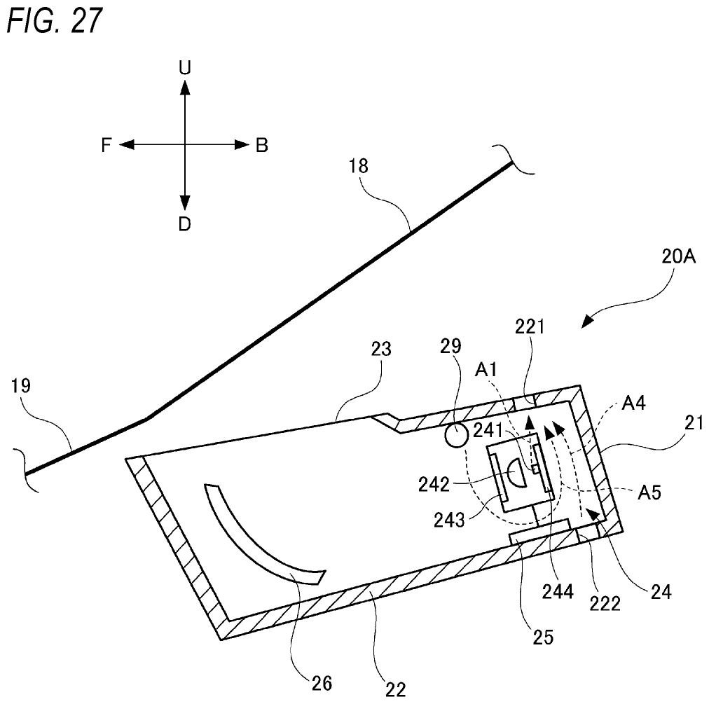

As illustrated in FIG. 27, the housing portion 22 of an HUD 20A may include an opening 221. The opening 221 may be provided in an upper portion of the housing portion 22 in a state where the HUD 20A is attached to the vehicle body 19 of the vehicle 1. In this example, the opening 221 is located above the image generation unit 24.

The heat generated by the light source 241 is discharged together with the air A1 from the opening 221 of the housing portion 22. In particular, when the opening 221 is located above the image generation unit 24, the heat generated by the light source 241 can be quickly discharged together with the air from the opening 221. Therefore, the heat dissipation efficiency is improved.

In addition, an opening 222 may be provided in a lower portion of the housing portion 22. As the rising air A1 flows, the air is taken into the housing portion 22 from the opening 222, and a convection A4 of the air rising inside the housing portion 22 is generated, so that the heat generated by the light source 241 is easily discharged together with the air A1 from the opening 221.

In addition to or in place of the opening 222, the HUD 20A may include a fan 29 for causing convection of the air in the housing portion 22. Since the fan 29 causes forced convection A5 of the air in the housing portion 22, the heat generated by the light source 241 is easily discharged together with the air.

Further, the image generation unit 24 of the HUD 20A may include a heat sink as illustrated in FIGS. 24 and 25.

Each of the heat sinks 245 and 245A is provided to cover the entire surface of the substrate 244, and a part thereof is located below the light source 241. However, the heat sinks 245 and 245A may be arranged such that the entire heat sinks 245 and 245A are located above the light source 241.

The light emitted from the image generation unit 24 is reflected by the concave mirror 26 and is radiated to the transmission member 18, but the present invention is not limited thereto. For example, the light reflected by the concave mirror 26 may be radiated to the combiner (not shown) provided inside the transmission member 18. The combiner is implemented by, for example, a transparent plastic disk. A part of the light radiated from the image generation unit 24 of the HUD main body 21 toward the combiner is reflected toward the viewpoint E of the occupant similarly to the case where the light is radiated to the transmission member 18.

Although the first to fourth embodiments of the present invention have been described above, it goes without saying that the technical scope of the present invention should not be limited to the description of the present embodiments. It should be understood by a person skilled in the art that the present embodiments are merely examples, and that various modifications are possible within the scope of the invention described in the claims. The technical scope of the present invention should be determined based on the scope of the invention described in the claims and the equivalent scope thereof.

The present application is based on Japanese Patent Application No. 2021-060971 filed on Mar. 31, 2021, Japanese Patent Application No. 2021-060972 filed on Mar. 31, 2021, Japanese Patent Application No. 2021-060973 filed on Mar. 31, 2021, and Japanese Patent Application No. 2021-060974 filed on Mar. 31, 2021, and the contents thereof are incorporated herein by reference.

1. An image generation device for generating a predetermined image, comprising:
an image generation unit configured to emit light for generating the predetermined image;
a first mirror configured to reflect the light; and
a bracket for attaching the image generation unit, wherein
the first mirror is held by the bracket.

2. The image generation device according to claim 1, wherein
the bracket includes
a base portion on which the image generation unit is mounted, and
a pair of protrusions arranged to sandwich the image generation unit and protruding from the base portion toward an emitting direction of the light from the image generation unit, and
the first mirror is mounted on the pair of protrusions.

3. The image generation device according to claim 2, wherein
a distal end portion of each of the pair of protrusions forms a certain angle with respect to a surface of the base portion on which the image generation unit is mounted, and
the first mirror is attached to the distal end portions.

4. An image irradiation device for a vehicle, comprising:
an image generation device according to claim 1; and
a second mirror configured to reflect the light emitted from the image generation unit and reflected by the first mirror such that the light is radiated toward a transmission member.

5. The image irradiation device according to claim 4, wherein
a distance between a light emitting surface of the image generation unit and a reflecting surface of the first mirror is shorter than a distance between the reflecting surface of the first mirror and a reflecting surface of the second mirror.

6. An image irradiation device for a vehicle that displays a predetermined image, comprising:
an image generation unit configured to emit light for generating the predetermined image; and
a rotatably arranged reflecting portion having a reflecting surface for reflecting the light emitted from the image generation unit, wherein
the reflecting surface has a curved surface having different curvature radii, and
the reflecting portion rotates such that the light incident on the reflecting portion is radiated toward the curved surface having different curvature radii.

7. The image irradiation device according to claim 6, wherein
the reflecting portion is displaceable at least between a first position and a second position by the rotation, and
a first irradiation region of the reflecting surface irradiated with the light incident on the reflecting portion when the reflecting portion is located at the first position partially overlaps a second irradiation region of the reflecting surface irradiated with the light incident on the reflecting portion when the reflecting portion is located at the second position.

8. The image irradiation device according to claim 6, wherein
the reflecting portion reflects upward the light emitted from the image generation unit by the reflecting surface, and
the reflecting surface is formed such that a curvature radius of an upper region is larger than a curvature radius of a lower region.

9. The image irradiation device according to claim 6, wherein
the reflecting portion is a concave mirror, and
the reflecting surface has a region curved in a recessed shape.

10. An image generation device comprising:
a light source;
a lens configured to transmit light emitted from the light source; and
a display device configured to form light for generating an image by using the light transmitted through the lens, wherein
the display device is inclined with respect to a direction perpendicular to an optical axis of the light source, and
the light source is deviated from a predetermined position and arranged at a position corresponding to the inclination.

11. The image generation device according to claim 10, wherein
the position deviation of a front light source with respect to the predetermined position is set according to an inclination angle of the display device with respect to the direction perpendicular to the optical axis of the light source.

12. An image irradiation device for a vehicle that displays a predetermined image, comprising:
an image generation device according to claim 10; and
at least one reflecting portion configured to reflect the light emitted from the image generation device.

13. An image irradiation device for a vehicle that displays a predetermined image, comprising:
an image generation unit including a light source and configured to emit light for generating the predetermined image by using light from the light source; and
a concave mirror configured to reflect the light emitted from the image generation unit, wherein
an optical axis of the light source is inclined downward toward the concave mirror in a state where the image irradiation device is attached to a vehicle body of the vehicle.

14. The image irradiation device according to claim 13, wherein
the image generation unit includes a heat sink that dissipates heat generated from the light source, and
at least a part of the heat sink is located above the light source in the state where the image irradiation device is attached to the vehicle body of the vehicle.

15. The image irradiation device according to claim 14, wherein
the heat sink includes a plurality of fins each protruding in a direction opposite to an emitting direction of the light from the light source, and
each of the plurality of fins is formed such that a length in a protruding direction increases toward an upper side in the state where the image irradiation device is attached to the vehicle body of the vehicle.

16. The image irradiation device according to claim 13, wherein
the image generation unit includes a wiring board on which the light source is mounted, and
the wiring board includes a base board made of a metal.

17. The image irradiation device according to claim 13, wherein
the image irradiation device includes a housing in which the image generation unit and the concave mirror are accommodated, and
an opening is provided in an upper portion of the housing in the state where the image irradiation device is attached to the vehicle body of the vehicle.

18. The image irradiation device according to claim 17, further comprising:
a fan for causing convection of air in the housing.
